(19) United States
(12) Patent Application Publication
(10) Pub. No.: US 2008/0199582 A1
(43) Pub. Date: Aug. 21, 2008

(54) Fat Products Containing Little or No Trans Fatty Acids

(75) Inventor: Ernie H. Unger, Idaho Falls, ID (US)

Correspondence Address: FISH & RICHARDSON P.C., PO BOX 1022, MINNEAPOLIS, MN, 55440-1022, US

(73) Assignee: CARGILL, INCORPORATED, Wayzata, MN (US)

(21) Appl. No.: 11/571,498

(22) PCT Filed: Jul. 1, 2005
(86) PCT No.: PCT/US2005/023359

§ 371 Date: Nov. 27, 2007

Related U.S. Application Data
(60) Provisional application No. 60/585,024, filed on Jul. 2, 2004.
(60) Provisional application No. 60/631,975, filed on Nov. 30, 2004.
(60) Provisional application No. 60/640,815, filed on Dec. 28, 2004.

(51) Int. Cl. A23D 9/02; A23D 9/007

(52) U.S. Cl. 426/519; 426/541; 426/606; 426/531; 426/549; 426/556; 426/607; 426/523; 426/560; 426/637; 426/559

(57) ABSTRACT

The present invention provides shortenings having little to no trans-fatty acids and low saturates. Such shortenings can be used to make various food products.

### TECHNICAL FIELD

This invention relates to fat products, and more particularly to shortenings containing low or no trans-fatty acids and low saturates.

### BACKGROUND

Dietary consumption of foods high in trans-fatty acids has been linked to increased serum cholesterol content. While some products containing no or low levels of trans fat have already been introduced, there are several factors that have limited the introduction of low or no trans fat alternatives into the marketplace. For example, replacements of trans fat must provide at least comparable characteristics of the final food product (e.g., flavor, texture, flakiness). Many of these highly desirable food characteristics are best achieved through the use of trans fats or saturated fats. Because saturates are often associated with increased blood cholesterol levels, it is not in the best interests of consumers or the food industry to increase saturates as a means to replace trans fats.

Some of the commonly used techniques to provide food products containing little or no trans fat include interesterification of unhydrogenated oils with high saturated fat base oils, the use of improved vegetable oils obtained by traditional plant breeding or biotechnology, the use of jelling or texture building agents, use of antioxidants to increase oil stability, blending of vegetable oils with partially hydrogenated fats, or a combination of any of the above.

### SUMMARY

The present disclosure describes blending hard fats having little to no trans fat with liquid oils having low saturated fats to thereby generate shortenings having little or no trans fat and low saturated fats. Blending a hard fat with a liquid oil produces a shortening that is plastic at room temperature and at initial baking conditions. Some embodiments of the invention provide shortenings having little to no trans-fatty acids and having low saturated fatty acids. The shortenings described herein have superior baking and frying attributes compared to commercially available shortenings.

In one aspect, the invention provides a shortening having about 11% to about 18% by weight hard fat and about 82% to about 89% by weight liquid oil (e.g., about 12.5% by weight hard fat and about 87.5% by weight liquid oil; about 14% by weight hard fat and about 86% by weight liquid oil; about 16% by weight hard fat and about 84% by weight liquid oil; or about 18% by weight hard fat and about 82% by weight liquid oil); about 5% by weight hard fat and about 95% by weight liquid oil; or about 7% by weight hard fat and about 93% by weight liquid oil. A liquid oil used in such a shortening can have from about 0.1% to about 7% α-linolenic acid based on total fatty acid content. In another aspect, the invention provides for shortenings having a solid fat content at 100° F. of about 2.5% to about 13% of the total fat and a trans-fatty acid content of about 0.5% to about 1.4% of the total fatty acid content.

In another aspect, the invention provides for food products containing a shortening of the invention. Representative non-limiting examples of food products include cake doughnut mix, raised yeast doughnut mix, sugar cookie mix, frozen biscuit mix, fresh biscuit mix, and machined pastry dough. The invention also provides for edible compositions made using a shortening of the invention such as a toaster pastry.

In an embodiment, a liquid oil used in a shortening of the invention has from about 1.4% to about 4.0% α-linolenic acid. In some embodiments, a shortening of the invention can include an antioxidant. A shortening of the invention can exhibit a solid fat content at 92° F. of about 4% to about 16% and/or a solid fat content at 104° F. of about 3% to about 13%. By way of example, a shortening of the invention can have about 11% to about 25% by weight saturated fatty acids, about 50% to about 70% by weight monounsaturated fatty acids, about 14% to about 23% by weight polyunsaturated fatty acids, and less than about 5% trans-fatty acids (e.g., less than about 1.5% by weight trans-fatty acids, or about 0.5% to about 1.3% by weight trans-fatty acid isomers).

In yet another aspect, the invention provides for a fat product having an 18:1 content from about 40% to about 65%, an 18:2 content of about 7% to about 23%, an 18:3 content of about 0% to about 3.0%, and less than about 1.5% by weight trans-fatty acids, based upon total fatty acid content; a fat product having an 18:1 content from about 45% to about 75%, an 18:2 content of about 3% to about 10%, an 18:3 content of about 0% to about 3.0%, and less than about 1.5% by weight trans-fatty acids, based upon total fatty acid content; a fat product having an 18:1 content from about 50% to about 80%, an 18:2 content of about 0% to about 5%, an 18:3 content of about 0% to about 2.5%, and less than about 1.5% by weight trans-fatty acids, based upon total fatty acid content; or a fat product having a change in peroxide value (PV) of less than 5 meq/kg after 15 days of accelerated aging.

In another aspect, the invention provides for food products comprising such fat products. Representative non-limiting examples of food products include cake doughnut mix, raised yeast doughnut mix, sugar cookie mix, frozen biscuit mix, fresh biscuit mix, and machined pastry dough. The invention also provides for edible compositions made using a shortening of the invention such as a toaster pastry.

By way of example, a fat product of the invention can exhibit a solid fat content at 92° F. of about 4.0 to about 13.0; and/or a solid fat content at 100° F. of about 3.0 to about 12.0. A fat product of the invention also can have about 0.5% to about 1.3% by weight trans-fatty acid isomers, or an 18:0 content of about 5.0% to about 15.0% based on total fatty acid content.

Representative liquid oils that can be used in a shortening or fat product of the invention include, without limitation, canola oil, sunflower oil, safflower oil, and soybean oil. Representative hard fats that can be used in a shortening or fat product of the invention include, without limitation, fully-hydrogenated cottonseed oil, cottonseed oil stearine, fully-hydrogenated soybean oil, soybean oil stearine, fully-hydrogenated palm oil, palm oil stearine, fully-hydrogenated canola oil, and canola oil stearine.

In still another aspect, the invention provides for methods of making a shortening. Such methods generally include providing a blend comprising about 11% to about 18% by weight hard fat and about 82% to about 89% by weight liquid oil, the liquid oil having from about 0.1% to about 7% α-linolenic acid based on total fatty acid content; cooling the blend; and tempering the blend to make the shortening. For example, the cooling step can include cooling the blend to between about 65° F. to about 82° F. in a scraped surface heat exchanger for about 1.0 to about 1.8 minutes, and the tempering step can include tempering at a temperature of about 60° F. to about 90° F. for about 24 hours to about 72 hours. In some embodiments, nitrogen can introduced into the blend during the cooling step.

In yet another aspect, the invention provides methods of malting a baked edible composition. Such methods generally include providing a food product made with a shortening or a fat product of the invention and baking the food product.

In yet another aspect, the invention provides methods of making a fried edible composition. Such methods generally include providing a food product made with a shortening or fat product of the invention and frying the food product. In an embodiment, the food product can be fried in a shortening or fat product of the invention.

In still another aspect, the invention provides for a frying shortening comprising about 5% to about 18% by weight hard fat and about 82% to about 95% by weight liquid oil. Typically, the liquid oil has from about 0.1% to about 7% (e.g., about 1.4% to about 4.0%) α-linolenic acid based on total fatty acid content. Representative liquid oils include canola oil, sunflower oil, safflower oil, or soybean oil. Representative hard fats include hydrogenated cottonseed oil, cottonseed oil stearine, hydrogenated soybean oil, soybean oil stearine, hydrogenated palm oil, palm oil stearine, hydrogenated canola oil, and canola oil stearine. Such a frying shortening also can include an antioxidant.

In various embodiments, a frying shortening of the invention can have about 5% by weight hard fat and about 87.5% by weight liquid oil; about 7% by weight hard fat and about 86% by weight liquid oil; about 10% by weight hard fat and about 84% by weight liquid oil; or about 15% by weight hard fat and about 82% by weight liquid oil. By way of example, a frying shortening of the invention can exhibit a solid fat content at 50° F. of about 10; a solid fat content at 70° F. of about 8; a solid fat content at 92° F. of about 6; and/or a solid fat content at 104° F. of about 4.5.

In another aspect, the invention provides for a food product comprising a frying shortening of the invention. Representative food products include frozen par-fried potatoes, finish-fried potatoes, frozen onion rings, tortilla chips, corn chips, extruded fried corn coletts, donut mix, sugar cookie mix, frozen biscuit mix, fresh biscuit mix, and machined pastry dough.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In addition, the materials, methods, and examples are illustrative only and not intended to be limiting. All publications, patent applications, patents, and other references mentioned herein are incorporated by reference in their entirety. In case of conflict, the present specification, including definitions, will control.

The details of one or more embodiments of the invention are set forth in the accompanying drawings and the description below. Other features, objects, and advantages of the invention will be apparent from the drawings and detailed description, and from the claims.

### DETAILED DESCRIPTION

Edible shortenings in certain embodiments of the invention are low in saturated fatty acids and in trans-fatty acids, and have superior baking and frying attributes when compared to commercially available vegetable and animal shortenings. The shortenings described herein have an oxidative stability equal to or better than the currently available partially hydrogenated vegetable and animal fat shortenings. Shortenings of the invention can be used to produce commercial and domestic baked and fried products with acceptable appearance, texture, shelf life, and other important properties.

### Characterizing Shortenings

Double bonds in fatty acids in crude vegetable oils tend to be in the “cis” configuration. Hydrogenation of such oils results in the formation of fatty acids having double bonds in the “trans” configuration. Saturated fatty acids are fatty acids that lack a carbon-to-carbon double bond, and include myristic (C_{14:0}), palmitic (C_{16:0}), stearic (C_{18:0}), arachidic (C_{20:0}), and lignoceric (C_{24:0}) acids.

Trans-fatty acids include any trans isomer of a C₁₄ through C₂₄ fatty acid, and can be detected using, for example, a method described by Madison, et al. (1982, J Amer. Oil Chem. Soc., 59:178-81). Free fatty acids are fatty acids that are not esterified. The amount of free fatty acids can be determined, for example, using American Oil Chemists'Society (AOCS) method Ca 5a-40. Fatty acid composition can be determined, for example, using AOCS method Ce 1e-91.

Iodine value (IV) is a measure of the unsaturated linkages in a fat and is expressed by the number of grams of iodine equivalent to halogen adsorbed by a 100 gram sample of fat. IV is a laboratory test; commercial fats do not contain iodine. IV can be measured, for example, using AOCS Official Method Cd 1-25, also known as the Wijs method. IV also can be determined from the fatty acid composition using AOCS Method Cd 1c-85.

Peroxide value (PV) is a measurement of unsaturated fatty acids, which is the primary oxidation product in oils, relative to total fatty acids. PV generally is expressed as milli-equivalents of peroxide-oxygen combined per kilogram of fat (meq/kg). PV can be determined, for example, using AOCS method Cd 8b-90.

Oxidative stability relates to how easily components of an oil oxidize, which creates off-flavors in the oil. The Oil Stability Index (OSI) method is used to determine oils and fats' resistance to rancidity. OSI results are expressed in hours at 110° C. OSI can be determined using an Oxidative Stability Instrument (Onion/Archer Daniels Midland, Decatur, Ill.) in accordance with AOCS method Cd 12b-92, for example. The Active Oxygen Method (AOM) is another rancidity test in which the fat to be tested is held at an elevated temperature (e.g., 98° C.) and through which air is bubbled at a specified rate. A peroxide value is determined at intervals. The endpoint is reported in hours required to reach a peroxide value of 100 meq/kg. AOM hours can be determined, for example, using AOCS method Cd 12-57. In addition, it is possible to correlate OSI results to AOM hours.

The Schaal oven method of accelerated aging is used to measure the oxidative and flavor stability of a fat or a fat-containing food product. The Schaal oven method involves examining samples of an oil or food product held at an elevated temperature at regular intervals. Sometimes the oil or food product is held in the dark. Results are reported as the time elapsing until a rancid odor or flavor is detected. Under certain Schaal oven conditions, one day is approximately equivalent to one-month storage in the dark at ambient temperature.

Solid fat index (SFI) is an empirical measurement of the solid fat content of a sample over a defined temperature scale. SFI is a dilatometric procedure relying on volumetric changes occurring during melting and crystallization. See, for example, AOCS Official Method Cd 10-57 (re'vd 1989). Solid fat content (SFC) is the actual percent of solid fat at standard temperature points. SFC is typically measured by pulsed nuclear magnetic resonance (PNMR). See, for example, AOCS Official Method Cd 16b-93. See, also, Bailey's Industrial Oil & Food Products, 5^{th} Ed., John Wiley & Sons, Inc., Vol. 4 (1996) for additional information on SFI and SFC.

The Mettler prop Point (MDP) is the temperature at which a solid fat becomes fluid to flow. The MDP can be determined, for example, using AOCS Official Method Cc 18-80 (re'vd 1989).

The color of an oil can be determined using, for example, AOCS method Cc 13b-43, and using, for example, an American Oil Tintometer (e.g., Model AF715, The Tintometer LTD., Salisbury, England). Color of oils is evaluated using a series of red and yellow standardized glass slides as references. Oil color, therefore, is reported in values of yellow and red.

Fry stability relates to the resistance to degeneration of the oil during frying. “Fry life” is the time it tales for the flavor of a product fried in an oil to degrade to a set sensory score.

Shelf-life stability of an oil or a food product made using an oil can be determined by analyzing food samples made with or cooked in the oil, and then packaged and stored in an oven at an elevated temperature to accelerate aging. “Shelf-life” is the time it takes for a food product to degrade to a set sensory score.

Flavor stability is the time it takes for the flavor of an oil to degrade to a set sensory score.

The plasticity or hardness (e.g., the rheological qualities) of a shortening can be evaluated using a cone penetrometer. For this assay, a cone with a particular angle (e.g., a 45° angle) generally is used. The depth of penetration into the sample and the penetration time can be measured. See, for example, Humphrey et al., 2003, J. Amer. Oil Chemists' Soc., 80:1175-1182; American Society for Testing and Materials (A.S.T.M.) Methods D-217, D-5 and D-937; and American Oil Chemist Society, Official Methods and Recommended Practices, 4^{th} Ed., 1996, AOCS Cc 16-60.

### Preparation of Shortenings

The term “shortening” refers to an oil (i.e., a fat product) that is plastic at ambient temperature (e.g., room temperature). See, for example, Campbell et al., Food Fats and Oils, 8^{th} Ed., Institute of Shortening and Edible Oils, Washington D.C. A shortening of the present invention is a combination of a hard fat (e.g., hydrogenated cottonseed oil, cottonseed oil stearine, hydrogenated soybean oil, soybean oil stearine, hydrogenated palm oil, palm oil stearine, hydrogenated canola oil, or canola oil stearine) and a liquid oil, preferably one low in saturated fats, such as canola oil, sunflower oil, safflower oil, or soybean oil. A shortening of the present invention possesses very little, if any, trans-fatty acids and possesses low levels of saturated fatty acids. Therefore, shortenings described herein are especially suitable for use in food products and/or for frying foods.

As indicated above, a number of different liquid oils can be used in a shortening of the invention. Although hydrogenated liquid oil can be used, liquid oil that has not been hydrogenated and has little or no trans-fatty acids (e.g., contains less than 2% or less than 1% trans-fatty acids (e.g., 0%, 0.1% to 2%, 0.2% to 1.8%, 0.4% to 1.8%, 0.6% to 1.0%, 0.8% to 1.6%, 1.0% to 1.8%, or 1.4% to 1.9%)) is preferred. A liquid oil suitable for use in the invention generally has less than about 7% α-linolenic acid (e.g., about 0.1% to about 7%, about 0.5% to about 7%, about 1% to about 5%, or about 2% to about 6%); between about 7% and about 56% of polyunsaturated fatty acids (e.g., about 10% to about 50%, about 8% to about 30%, about 15% to about 45%, or about 20% to about 40%); and/or less than about 15% saturated fatty acids (e.g., less than about 12%, 10%, 8%, 5%, 3%, or 1%).

Non-limiting examples of suitable liquid oils that can be used in a shortening of the invention include Clear Valley 65® (CV 65®; Cargill, Minnetonka, Minn.), Clear Valley 75® (CV 75®; Cargill, Minnetonka, Minn.), and Clear Valley 85® (CV 85®; Cargill, Minnetonka, Minn.). CV 65®, CV 75®, and CV 85® are refined, bleached and deodorized oils produced from seeds of low α-linolenic acid Brassica napus plant lines. Additional non-limiting examples of suitable liquid oils that can be used in the shortenings described herein include, for example, mid-oleic sunflower oil (NuSun®), low-linolenic soybean oil, mid-oleic, low-linolenic soybean oils, and low-linolenic canola oils other than those discussed herein. Table 1 shows the typical characteristics of CV 65®, CV 75®, CV 85®, and a representative high oleic sunflower oil.

TABLE 1
Characteristics of CV 65 ®, CV 75 ®, CV 85 ®
and a High Oleic Sunflower Oil

| | | | | High Oleic |
|---|---|---|---|---|
| | | | | Sunflower |
| | CV 65 ® | CV 75 ® | CV 85 ® | Oil |
| Oleic Acid, % | 60-70 | 73-80 | 78-85 | 78-86 |
| Linoleic Acid, % | 15-25 | 8-15 | 3-8 | 6-12 |
| Erucic Acid, % | <2 | <2 | <2 | ND* |
| α-Linolenic Acid, % | 2-5 | 2-5 | 1.5-3.5 | <0.5 |
| Total Sats, % | 6-7.5 | 6-7.5 | 5-7 | 8-10 |
| Trans-fatty acids, % | 0.5-1.1 | 0.5-1.1 | 0.5-1.1 | 0 |
| IV | <115 | <95 | <89 | <87 |
| AOM, hours | ~30 | ~37 | ~65 | >40 |

*ND, not detectable

The α-linolenic acid content in the CV 65® oil typically is from about 2.5% to about 4.5% (e.g., about 2.6% to about 4%, about 3% to about 3.8%, or about 3.5% to about 4.4%). CV 65® oil has an oleic acid content of about 60% to about 75% by weight (e.g., about 62% to about 70%, about 65% to about 72%, or about 67% to about 73%), a linoleic acid content of about 15% to about 25% by weight (e.g., about 16% to about 23%, about 18% to about 20%, or about 20% to about 24%), and an erucic acid content of less than about 2% by weight (e.g., less than about 1.8%, 1.5%, 1.0%, or 0.8%). The CV 65®, CV 75®, and CV 85® oils have a trans-fatty acid content of about 0.5% to about 1.1% (e.g., about 0.6% to about 1.0%, about 0.7% to about 0.9%, or about 0.9 to about 1.1%). CV 65® oil generally has an iodine value of less than about 115 (e.g., less than about 110, 105, or 100) and an AOM value of about 30 hours (e.g., about 28, 32, or 35 hours); CV 75® oil generally has an iodine value of less than about 95 (e.g., less than about 90, 85, or 80) and an AOM value of about 37 hours (e.g., about 35, 38, or 40 hours); CV 85® oil generally has an iodine value of less than about 89 (e.g., less than about 85, 80, or 75) and an AOM value of about 65 hours (e.g., about 62, 68, or 70 hours).

Liquid oils used in shortenings of the invention are generally refined, bleached and deodorized (RBD) oils. Refining refers to removing most if not all free fatty acids and other impurities such as phosphatides or protein substances from a crude oil. One common method of refining is done by treating an oil with a strong base, followed by extensive washings with water. Bleaching refers to a process that removes natural pigments (carotenoids, chlorophylls, and xanthophylls) and other impurities such as metal cations (e.g., Fe, Cu, and Zn). Bleaching can be done by absorbing such pigments and/or cations on a natural bleaching earth or clay, which is usually added to an oil under vacuum and high temperature. Deodorizing refers to the removal of relatively volatile trace components (e.g., ketones, aldehydes, alcohols,) from an oil that contribute to flavor, odor, and color. Deodorizing is usually done by injecting steam into an oil heated to high temperatures (e.g., about 470° F. to about 510° F.) under high vacuum (e.g., <5 mm Hg).

A hard fat used in a shortening described herein contains few or no double bonds in fatty acyl moieties of the fat. In some embodiments, a fat having unsaturated bonds can be hydrogenated to form a hard fat suitable for use as described herein. Hydrogenation can be done, for example, at a high temperature and under high pressure. Standard batch hydrogenation equipment featuring internal steam heating and water-cooling can be used. A nickel catalyst such as Nysosel SP7 (Engelhard, Cleveland, Ohio), or Pricat 9908 (Unichem, Emmerich, Germany) can be used during hydrogenation. See, for example, U.S. Pat. Nos. 1,275,405; 1,390,687; 4,163,750; and 6,218,556. A hard fat used in a semi-solid (e.g., plasticized) shortening as described herein generally is hydrogenated to an Iodine Value (IV) of less than 5 meq (e.g., less than 3 meq), which, in the case of cottonseed hard fat, results in the presence of less than 2% trans-fatty acids. Alternately, a hard fat used in a frying shortening as described herein need only be hydrogenated to an IV of about 10 meq (e.g., about 9 meq, 11 meq, or 12 meq).

The hard fat used in a shortening of the invention also can be a stearine fraction. A stearine fraction primarily consists of stearic acid, a saturated 18-carbon fatty acid, and palmitic acid, a saturated 16-carbon fatty acid. Fractionation methods using differences in melting point or volatility, for example, can be used to obtain a stearine fraction from, for example, cottonseed oil, soybean oil, palm oil, and canola oil. See, for example, Bailey's Industrial Oil & Fat Products, 5^{th} Ed., Hui, Ed., John Wiley & Sons, Inc., 1996.

In some embodiments, the hard fat and the liquid oil are combined at a ratio of between about 11% and about 18% hard fat (e.g., about 12.5% to about 15%, or about 15% to about 17%), and between about 82% and about 89% liquid oil (e.g., about 83% to about 87.5%, or about 85% to about 88%). Blending of the liquid oil and the hard fat requires melting of the hard fat, which can be done prior to, during, or after addition of the liquid oil. Hard fats suitable for use in the invention typically melt at about 136° F. to about 147° F. Antioxidants (see below) can be added to the blend.

The blend is then moved into one or more scraped-surface heat exchangers, which can utilize, for example, glycol, brine, freon, or liquid ammonia as a means to cool the heat exchanger(s). The blend is pumped through the heat exchanger(s) and sufficient heat is removed by super cooling to cause crystallization (solidification) of the fat. The residence time in the heat exchanger(s) of the shortenings described herein generally is at least 31 seconds up to about 90 seconds (e.g., 31 seconds to about 45 seconds, 31 seconds to about 60 seconds, 31 seconds to about 75 seconds, 35 seconds to about 50 seconds, or 40 seconds to about 55 seconds). The temperature at which the shortenings described herein can be votated generally are about 18° C. to about 28° C. (e.g., about 18.5° C. to about 27.5° C., about 20° C. to about 25° C., or about 22° C. to about 26° C.). The heat exchange process, commonly referred to as “votation,” may be conducted using a Votator-brand heat exchanger (Waukesha Cherry-Burrell, Delevan, Wis.), for example.

The solidified product exiting the votator is a homogeneous composition with homogeneous consistency. Votation followed by agitation in, for example, a “pin” unit, facilitates the formation of crystal structure such that the resulting shortening is smooth in appearance and firm in consistency. By varying the conditions of the votation process, products for different applications (e.g., baking, creaming, or frying) can be produced. The machined process of forming crystals and making a semi-solid shortening (i.e., semi-solid at ambient temperatures), including the step of votation, is known as plasticizing.

Nitrogen can be introduced into the blend at the time of entry into the scraped surface heat exchanger. The nitrogen provides for improved creaminess and a white appearance of the final shortening product.

Upon exiting of the blend from the votator, the crystals begin to matrix very rapidly and a firm shortening is formed. The liquid oil is interspersed with the crystals of the hard fat, forming a uniform shortening. The shortening can be tempered, for example, at 65° F. to 90° F. for 24 to 96 hours to allow the crystal structure to develop and stabilize.

The shortenings of the invention that contain a hard fat other than palm oil (e.g., cottonseed, soybean, safflower, and canola) typically have an average oxidative stability of about 25 to about 45 AOM hours in the absence of an antioxidant (e.g., about 30 to about 40, about 35 to about 42, or about 40 to about 44 hours) and generally exceeds about 60 AOM hours in the presence of an antioxidant (e.g., about 65 to about 70, or about 70 to about 75 hours). The MDP of the shortenings generally is about 100° F. to about 140° F. (e.g., about 105° F. to about 135° F., about 110° F. to about 130° F., about 115° F. to about 125° F., or about 120° F. to about 135° F.). The solid fat content (SFC) for a representative shortening of the invention is as follows: at 50° F., about 5% to about 20% (e.g., about 7% to about 18%, about 10% to about 15%, or about 12% to about 14%); at 70° F., about 4% to about 18% (e.g., about 5% to about 15%, about 7% to about 12.5%, or about 10% to about 15%); at 80° F., about 3.5% to about 17% (e.g., about 5% to about 15%, about 7% to about 12.5%, or about 10% to about 14%); at 92° F., about 3% to about 15% (e.g., about 5% to about 14%, about 7.5% to about 12.5%, or about 10% to about 13%); at 100° F., about 2.5% to about 13% (e.g., about 3% to about 12%, about 5% to about 10%, or about 7.5% to about 10%); and at 104° F., about 2% to about 12% (e.g., about 3% to about 10%, or about 5% to about 8%). The shortenings of the invention can have an average IV of about 75 to about 105 (e.g., about 80 to about 100, about 90 to about 100, or about 80 to about 95), and an average peroxide value of about 0.20 meq/kg to about 1.1 meq/kg (e.g., about 0.4 to about 1.0, 0.6 to about 0.8, or about 0.5 to about 0.9 meq/kg). The shortenings of the invention generally have the following fatty acid profiles: an average saturated fatty acid content of about 11% to about 25% (e.g., about 12% to about 23%, about 15% to about 20%, about 18% to about 22.5%); an average total trans-fatty acid content of about 0% to about 2% (e.g., about 0.1% to about 1.8%, about 0.3% to about 1.5%, about 0.6% to about 1.2%, or about 1.0% to about 1.5%); an average α-linolenic acid content of about 1.4% to about 4.0% (e.g., about 1.5% to about 3.8%, about 2% to about 3.5%, or about 2.5% to about 3%); an average monounsaturated fatty acids of about 50% to about 70% (e.g., about 55% to about 65%, about 60% to about 68%, or about 58% to about 65%); and an average polyunsaturated fatty acid content of about 14% to about 23% (e.g., about 15% to about 20%, or about 18% to about 22%).

The shortenings of the invention containing, for example, palm oil or palm kernel oil (e.g., fully-hydrogenated or stearine fraction) as the hard fat can have an oxidative stability of about 75 to about 90 AOM hours (in the presence of an antioxidant; e.g., about 76 to about 88, or about 80 to about 85 hours). The MDP of shortenings containing palm oil generally is about 115° F. to 130° F. (e.g., about 120° F. to about 125° F.). Shortenings of the invention that contain palm oil typically have a solid fat content (SFC) as follows: at 50° F., about 25% to about 45% (e.g., about 30% to about 40%, or about 35% to about 42%); at 70° F., about 15% to 35% (e.g., about 20% to about 30%, or about 25% to about 33%); at 80° F., about 12% to about 28% (e.g., about 15% to about 25%, or about 18% to about 22%); at 92° F., about 10% to about 20% (e.g., about 12% to about 18%, or about 15% to about 20%); at 100° F., about 7% to about 17% (about 10% to about 15%, or about 12% to about 16%); and at 104° F., about 6% to about 16% (e.g., about 8% to about 15%, or about 10% to about 14%). The shortenings of the invention containing palm oil also can have an average IV of about 65 to about 80 (e.g., about 70 to about 75), and an average peroxide value of about 0 meq/kg to about 6 meq/kg (e.g., about 0.1 to about 5.8, about 0.5 to about 5.5, about 1.0 to about 5.0, about 1.5 to about 4.5, about 2.0 to about 4.0, about 2.5 to about 4.0, or about 3.0 to about 3.5 meq/kg). The shortenings of the invention containing palm oil as the hard fat generally have the following fatty acid profiles: an average saturated fatty acid content of about 25% to about 40% (e.g., about 30% to about 35%); an average total trans-fatty acid content of about 0% to about 1.3% (e.g., about 0.1% to about 1.0%); an average α-linolenic acid content of about 0.8% to about 1.7% (e.g., about 1.0% to about 1.5%); an average monounsaturated fatty acids of about 45% to about 65% (e.g., about 50% to about 60%); and an average polyunsaturated fatty acid content of about 10% to about 20% (e.g., about 12% to about 15%, or about 15% to about 18%).

Common additives can be added to the shortening of the present invention such as stabilizers, flavoring agents, emulsifiers, anti-spattering agents, colorants, or antioxidants. See, for example, Campbell et al., Food Fats and Oils, 8^{th} Ed., Institute of Shortening and Edible Oils, Washington, D.C. for information on a variety of additives.

The above-described shortenings provide unique solid fat content profiles that are different from that of shortenings produced with hydrogenated oils or other blends of oils.

### Food Products

The shortenings described herein can be incorporated into doughs or mixes to make food products such as donuts, pizzas, crusts (e.g., pie crusts), cookies, biscuits, pastries (e.g., toaster pastries), bread, or the cream in a cream-filled food product (e.g., Oreo® cookies). Since the shortenings described herein contain little to no trans-fatty acids, food products made with such shortenings contain reduced levels of or no trans-fatty acids per serving compared to the same food product made using many other known shortenings.

Nutrition Facts label serving sizes are based on the amount of food customarily eaten at one time (called the “reference amount”) as reported from nationwide food consumption surveys. (USDA & DHHS, 2000, Nutrition and Your Health: Dietary Guidelines for Americans, Fifth Ed., Home and Garden Bulletin No. 23). Serving sizes are based on reference amounts in one of three ways (FDA Center for Food Safety and Applied Nutrition, 2000, Food Labeling and Nutrition). For bulk products, such as cereals and flour, the Nutrition Facts labels use common household terms such as cup, tablespoon, teaspoon, and fluid once at a quantity that is closest to the reference amount for that item. For products that are usually divided from consumption, such as cake or pizza, the serving size is a fractional amount of the product (e.g., “¼ pizza”). Products that come in defined, discrete units—such as eggs and sliced products—are normally listed as the number of whole units that most closely approximates the reference amount. For example, cookies have a reference amount of 30 g. Thus, the serving size on a package of cookies weighing about 30 g each would be “1 cookie.”

A food product also can be made using flakes of a shortening described herein. Flaked shortenings can be more evenly distributed in the food product during manufacturing, thereby reducing production time and energy costs. Flaked shortenings can result in a flakier crust or a softer crumb depending on the food product, because, typically, they are not “released” until the food product is baked by a consumer. The shortenings described herein also can be used in an icing product, or as a coating on a food product.

A food product also or alternatively can be cooked (e.g., fried) in a shortening described herein. The normal temperature range for frying with a shortening of the invention is 325° F. to 375° F. Most foods cook rapidly in this range and develop a golden color, crisp texture and good flavor. Frying time is longer at lower temperatures, and results in lighter color, less flavor, and increased oil absorption. On the other hand, frying time is shorter at higher temperatures, and generally leads to thinner, crispier crusts and less oil absorption.

Food products can be evaluated using mechanized procedures such as DIPIX® instrumentation (Ottawa, Canada). DIPIX® technology provides inspection systems for food products. DIPIX® Inspection Systems can inspect the 3-dimensional features such as thickness, height, and end-to-end or center-to-end slope, the 2-dimensional features such as length, width, minimum diameter, maximun diameter, and ovality, and bake color features such as bake color of edges, background, and ridges and valleys. DIPIX® Inspection Systems also can inspect the optical density of a food product to detect holes and/or uncooked portions of a food product. Additional information can be found at dipix.com on the World Wide Web.

A food product and the effect of a particular ingredient or process also can be evaluated by examining the sensory attributes of a food product. Sensory attributes include, for example, color, tenderness, amount of cracking, gumminess, chewiness, moistness, hardness, flavor quality, mouth coating, finger oiliness, and graininess. Sensory attributes of food products are usually determined by a trained sensory panel. A sensory panel refers to those individuals involved in the sensory evaluation of the edible food product. Panelists are pre-screened to be able to detect the flavor differences in the particular product tested and are trained in sensory descriptions. A panel provides qualitative and quantitative scores for the sensory evaluation that are referenced against calibrated standards.

Either or both the DIPIX® results and the sensory panel results can be analyzed for statistical significance. Statistical significance generally refers to a p-value of less than 0.05, e.g., a p-value of less than 0.025 or a p-value of less than 0.01, using an appropriate parametric or non-parametric measurement, e.g., a one-tailed two-sample t-test. Standard deviation was also measured for many features.

### Preparation and Characterization of Frying Shortenings

Frying shortenings are also provided herein that are low in saturated fatty acids and in trans-fatty acids, and that have superior frying attributes when compared to commercially available vegetable and animal oils. The shortenings described herein have an oxidative stability equal to or better than many available vegetable and animal shortenings. The invention provides for a shortening that can be used to produce commercial fried products with acceptable appearance, texture, and shelf life.

The term “frying shortening” refers to a fat product that is a combination of a hard fat (e.g., hydrogenated cottonseed oil, cottonseed oil stearine, hydrogenated soybean oil, soybean oil stearine, hydrogenated palm oil, palm oil stearine, hydrogenated canola oil, or canola oil stearine) and a liquid oil such as canola oil, sunflower oil, safflower oil, or soybean oil. It is desirable that the liquid oil is low in saturated fats. A frying shortening of the present invention possesses very little, if any, trans-fatty acids and possesses low levels of saturated fatty acids. Therefore, frying shortenings described herein are especially suitable for use in frying foods. A frying shortening has a partially melted consistency at room temperature. A frying shortening thus has a cloudy appearance at room temperature and generally is not clear and bright.

A number of different liquid oils are suitable for use in making a frying shortening of the invention. Although hydrogenated liquid oil can be used, liquid oil that has not been hydrogenated and has little or no trans-fatty acids (e.g., contains less than 2% or less than 1% trans-fatty acids) is preferred. Non-limiting examples of suitable liquid oils that can be used in a frying shortening of the invention include CV 65®, CV 75®, and CV 85®. Liquid oils used in frying shortenings are generally RBD oils.

A hard fat used in a frying shortening described herein contains few or no double bonds in fatty acyl moieties of the hard fat. In some embodiments, a fat having unsaturated bonds can be partially or fully hydrogenated to form a hard fat, e.g., partially or fully hydrogenated cottonseed oil, soybean oil, palm oil, or canola oil. A hard fat used in a frying shortening also can be a stearine fraction from, for example, cottonseed oil, soybean oil, palm oil, or canola oil. Typically, a hard fat for a frying shortening has an Iodine Value (IV) of less than 15 meq (e.g., 4 to 15 meq, 5 to 15 meq, 8 to 13 meq, 5 to 11 meq, 7 to 13 meq, 12 meq, 11, meq, 10 meq, 9 meq, 8 meq, 7 meq, 6 meq, 5 meq, 4 meq, or 3 meq). A hard fat suitable for use in a frying shortening of the invention typically melts at about 136° F. to about 147° F. (e.g., 138° F., 140° F., 142° F., or 145° F.).

A hard fat and a liquid oil are combined in a proportion of from 4% to 20% hard fat, and from 80% to 96% liquid oil. Thus, the proportion of hard fat can be from 5% to 12%, from 4% to 14%, from 6% to 11%, from 6% to 15%, from 7% to 15%, from 8% to 15%, from 8% to 12%, from 5% to 10%, or from 9% to 17%. A frying shortening of the invention should contain a sufficient amount of hard fat such that when the frying shortening is distributed on a food product prior to frying, the liquid oil is entrained in the hard fat in a thin layer upon the food product. Entrapment of liquid oil prevents the food product from “oiling out” at room temperature. The proportion of hard fat to liquid oil in a frying shortening of the invention can be varied as desired for a particular food product, e.g., due to variation in water content or length of frying time required.

The hard fat can be melted prior to, during, or after addition of liquid oil. However, the hard fat typically is melted by heating to about 140° F. and liquid oil, heated to about 120° F., is then added to the melted hard fat. In other embodiments, a hard fat is added to heated liquid oil and the mixture is blended while maintaining a temperature that permits melting of the hard fat. Additives such as antioxidants and/or flavorings (see below) can be added to the blend. Typically, the blended mixture is not votated, thus allowing the formation of different crystal structures than those that form upon supercooling. The frying shortening can be allowed to slowly cool to room temperature. The frying shortening can be used immediately, e.g., in a par fry operation to make par-fried food products, or can be stored, e.g., at room temperature, for a period of time before use.

Food Products Comprising a Frying Shortening

Frying shortenings described herein can be used for frying, par frying, and/or finish frying of food products, including battered and/or breaded food items. Food products that can be fried in a frying shortening of the invention include, without limitation, donuts, onion rings, french fries, and hash browns. Food products that can be par-fried in a frying shortening of the invention include, without limitation, onion rings, french fries, hash browns, fish, e.g., fish sticks, beef, e.g., chicken-fried steak, and poultry. Food products that can be finish-fried in a flying shortening of the invention include, without limitation, onion rings, shrimp, fish, beef, pork, poultry, vegetable pieces, donuts, tortilla chips, corn chips, potato chips, and extruded fried corn collets (e.g., Cheetos®).

In addition to the above-indicated food products, fried or par-fried food products may contain additional components, for example, to coat the food product (e.g., batter, breading, or flakes), to provide natural and/or artificial flavors (e.g., sugar, salt, garlic powder, or onion powder), to control the consistency of the food product and/or the coating (e.g., dextrose, xanthan gum, starch, flour, dextrin, gelatin, and/or leavening agents such as disodium dihydrogen pyrophosphate or sodium bicarbonate), and/or as preservatives (e.g., sodium acid pyrophosphate).

Oil quality can be measured on a frying shortening using procedures described herein. An additional index of the quality of a frying shortening is water emulsion titratables, which can be determined using AOCS method Cc17-79.

A typical temperature range for par frying is 375° F. to 400° F. (e.g., 380° F. to 390° F.), while a typical temperature range for food service finish frying is from 325° F. to 375° F. (e.g., from 340° F. to 360° F.). The length of time a food product is par-fried and/or finish-fried generally is determined by the particular food product. The conditions for frying or par-frying a particular food product are known or can be readily determined by those of skill in this art.

The invention will be further described in the following examples, which do not limit the scope of the invention described in the claims.

### EXAMPLES

### Example 1

### Making a Shortening Having Little or No Trans-Fatty Acids

Liquid, low α-linolenic acid RBD canola oil (CV 65®) was combined with different amounts of hydrogenated cottonseed hard fat as indicated below in Tables 2, 3, 4, and 5. The processing conditions are shown in Table 2. The combination was fully melted at approximately 130° F. to produce a blend. If indicated, antioxidants were added to the blend before votation to increase the oxidative stability of the oils to greater than 70 hours AOM as measured by an OSI instrument.

The blend was votated through a scraped surface heat exchanger called a “C” unit. The heat exchanger was cooled with refrigerated liquids that include glycol, brine, or freon. The blend was cooled through the “C” unit to 65° F. to 82° F. The rapid cooling through the scraped surface heat exchanger resulted in super-cooled oil crystals that remained fluid. Retention time in the “C” unit was typically 0.5 to 0.7 min.

Immediately after passing through the scraped surface heat exchanger, the cooled blend was passed through a pin unit. Some heat from crystallization was evident through the pin unit, where temperatures of the blend exiting the pin unit were typically 2° F. to 5° F. higher than the inlet temperature. The retention time in the pin unit was typically 0.5 to 1.0 min.

TABLE 2
Formulation and Processing Conditions

| | Shortenings | | |
|---|---|---|---|
| | TE-3-70 | TE-3-125 | TE-3-50 |
| Formulation | | | |
| CV 65 ® RBD, % | 93.0 | 87.5 | 95.0 |
| Cottonseed Hard Fat (CSHF), % | 7.0 | 12.5 | 5.0 |
| Process Conditions | | | |
| Blend Tank Temp. ° C. | 50-55 | 60 | 50-55 |
| Votator Temp,‘C’ Unit, ° C. | 21-23 | 23-26 | 21-23 |
| Votator Temp, Pin Unit, ° C. | 23-25 | 27-30 | 22-24 |

If indicated, nitrogen was introduced into the blend at the oil inlet flow of the scraped-surface heat exchangers. Upon exiting of the blend from the scraped-surface heat exchanges and the pin unit, the crystals began to matrix very rapidly and a shortening was formed. The shortening was tempered at 65° F. to 90° F. for about 48 hours to allow the crystal structure to develop and stabilize.

The shortenings remained in a stable crystal structure at room temperatures. As the amount of hard fat was increased to approximately 7%, the shortening could be stored at typical warehouse temperatures of 80° F. for several months without separation of the liquid oil from the crystal matrix.

Tables 3, 4, and 5 show the analysis of the indicated shortenings and Table 6 shows the analysis of a commercial Progressive Baker All Purpose Shortening (Cargill, Minnetonka, Minn.). Table 7 shows the results of the Schaal Oven Tests to examine the stability of the shortenings. The Schaal oven test was performed according to AOCS Method Cg 5-97.

TABLE 3
Analysis of Shortenings

| | TE-3-50 | TE-3-70 | TE-3-125 |
|---|---|---|---|
| CV 65 ® RBD, % | 95.0 | 93.0 | 87.5 |
| Cottonseed Hard Fat (CSHF), % | 5.0 | 7.0 | 12.5 |
| Free Fatty Acids, % | 0.04 | 0.05 | 0.05 |
| Peroxide Value, meq/kg | 0.45 | 0.80 | 0.90 |
| Mettler Drop Point, ° F. | 111.7 | 113.0 | 128.1 |
| AOM, hours | 34.60 | | 37.12 |
| Fatty Acid Profile, % | | | |
| C16:0 | 5.8 | 5.6 | 6.2 |
| C16:1 | 0.3 | 0.3 | 0.3 |
| C18:0 | 7.1 | 6.0 | 7.3 |
| C18:1 | 62.1 | 62.8 | 61.6 |
| C18:2 | 19.7 | 19.4 | 18.9 |
| C18:3 | 1.9 | 2.0 | 2.0 |
| C20:0 | 1.1 | 1.0 | 1.0 |
| C20:1 | 1.2 | 1.3 | 1.2 |
| C22:0 | 0.5 | 0.5 | 0.5 |
| C22:1 | 0.2 | 0.2 | 0.2 |
| C24:0 | 0.3 | 0.3 | 0.3 |
| C24:1 | 0.1 | 0.4 | 0.3 |
| Total Saturated FA, % | 14.9 | 13.5 | 15.4 |
| Total trans FA, % | 1.1 | 1.1 | 1.1 |
| Iodine Value | 93.7 | 94.3 | 92.2 |
| Solid Fat Content, % | | | |
| 50° F. | 7.5 | 9.9 | 16.3 |
| 70° F. | 6.1 | 8.0 | 14.0 |
| 80° F. | 5.3 | 7.1 | 12.8 |
| 92° F. | 4.5 | 6.1 | 11.2 |
| 100° F. | 3.7 | 5.1 | 9.5 |
| 104° F. | 2.9 | 4.6 | 8.8 |
| Additives | none | none | none |

TABLE 4
Analysis of Shortenings

| | TE-3-70 | TE-3-125 | TE-3-140 | TE-4-350 |
|---|---|---|---|---|
| CV 65 ® RBD, % | 93.0 | 87.5 | 86.0 | 65.0 |
| Cottonseed Hard Fat | 7.0 | 12.5 | 14.0 | |
| (CSHF), % | | | | |
| Hydrogenated Palm Oil, % | | | | 35.0 |
| Free Fatty Acids, % | 0.04 | 0.04 | 0.04 | 0.04 |
| Peroxide Value, meq/kg | 0.57 | 0.42 | 0.32 | 3.80 |
| Mettler Drop Point, ° F. | 118.2 | 126.6 | 127.3 | 120.3 |
| Color (5¼″) | 4.7Y; | 5.1Y; | 5.6Y; | |
| Yellow; Red | 0.5R | 0.6R | 0.6R | |
| AOM, hours | 90.5 | 94.8 | 94.3 | 81.7 |
| Fatty Acid Profile, % | | | | |
| C16:0 | 5.9 | 7.1 | 7.3 | 27.6 |
| C16:1 | 0.2 | 0.2 | 0.2 | 0.2 |
| C18:0 | 7.7 | 11.7 | 12.5 | 3.2 |
| C18:1 | 62.5 | 58.7 | 57.0 | 50.9 |
| C18:2 | 18.5 | 17.3 | 17.0 | 14.2 |
| C18:3 | 2.0 | 1.9 | 1.8 | 1.3 |
| C20:0 | 0.8 | 0.8 | 0.8 | 0.6 |
| C20:1 | 1.2 | 1.1 | 1.1 | 0.8 |
| C22:0 | 0.4 | 0.5 | 0.5 | 0.2 |
| C22:1 | 0.1 | 0.1 | 0.1 | 0.2 |
| C24:0 | 0.3 | 0.5 | 0.8 | 0.2 |
| C24:1 | 0.1 | 0.2 | 0.3 | 0.1 |
| Total Saturated FA, % | 15.2 | 20.4 | 22.4 | 32.4 |
| Total trans FA, % | 1.3 | 1.0 | 1.0 | 0.7 |
| Iodine Value | 92.2 | 86.6 | 84.4 | 72.6 |
| Solid Fat Content, % | | | | |
| 50° F. | 8.4 | 14.3 | 15.8 | 33.3 |
| 70° F. | 7.3 | 12.8 | 14.1 | 23.8 |
| 80° F. | 6.6 | 11.8 | 13.0 | 19.1 |
| 92° F. | 5.2 | 10.1 | 11.1 | 15.0 |
| 100° F. | 4.7 | 8.7 | 9.8 | 12.3 |
| 104° F. | 4.0 | 8.4 | 8.8 | 11.1 |
| Additives | | | | |
| TBHQ, ppm | 150 | 150 | 150 | 150 |
| Nitrogen at Votation | yes | yes | yes | yes |

TABLE 5
Analysis of Shortenings

| | TE-3-50 | TE-3-160 |
|---|---|---|
| CV 65 ® RBD, % | 95.0 | 84.0 |
| Cottonseed Hard Fat (CSHF), % | 5.0 | 16.0 |
| Free Fatty Acids, % | 0.03 | 0.03 |
| Peroxide Value, meq/kg | 0.55 | 0.62 |
| Mettler Drop Point, ° F. | 111.5 | 129.3 |
| AOM, hours | 80.3 | 91.3 |
| Fatty Acid Profile, % | | |
| C16:0 | 5.8 | 7.1 |
| C16:1 | 0.3 | 0.3 |
| C18:0 | 7.0 | 13.4 |
| C18:1 | 62.4 | 59.9 |
| C18:2 | 19.2 | 14.2 |
| C18:3 | 1.9 | 2.0 |
| C20:0 | 1.0 | 0.8 |
| C20:1 | 1.3 | 1.1 |
| C22:0 | 0.4 | 0.4 |
| C22:1 | 0.2 | 0.1 |
| C24:0 | 0.3 | 0.2 |
| C24:1 | 0.2 | 0.2 |
| Total Saturated FA, % | 14.5 | 22.1 |
| Total trans FA, % | 0.7 | 0.7 |
| Iodine Value | 93.3 | 82.9 |
| Solid Fat Content, % | | |
| 50° F. | 7.3 | 18.4 |
| 70° F. | 5.9 | 16.3 |
| 80° F. | 5.0 | 15.3 |
| 92° F. | 4.0 | 13.3 |
| 100° F. | 3.1 | 11.8 |
| 104° F. | 2.8 | 10.8 |
| Additives | | |
| TBHQ, ppm | 150 | 150 |
| Nitrogen at Votation | yes | yes |

TABLE 6
Analysis of Control Shortening

| | All Purpose Shortening |
|---|---|
| | Partially hydrogenated soybean oil; |
| Ingredients | partially hydrogenated cottonseed oil |
| Free Fatty Acids, % | 0.05 max |
| Peroxide Value, meq/kg | 1.0 max |
| Mettler Drop Point, ° F. | 112 to 119 |
| AOM, hours | 75 min |
| Total Saturated FA, % | 22 to 25 |
| Total trans FA, % | 30 to 33 |
| Solid Fat Content, % | |
| 50° F. | 27 to 33 |
| 70° F. | 17 to 21 |
| 80° F. | |
| 92° F. | 10 to 17 |
| 100° F. | |
| 104° F. | 7 to 12 |
| Additives | |
| Nitrogen at Votation | yes |

TABLE 7
Shortening Stability Study - Schaal Oven Tests

| | Crisco* | TE-3-50 | TE-3-70 | TE-3-125 | TE-3-140 | TE-3-160 | TE-4-350 |
|---|---|---|---|---|---|---|---|
| FAD (Day 0) | | | | | | | |
| 14:0 | 0.19 | 0.07 | 0.09 | 0.13 | 0.14 | 0.15 | 0.55 |
| 16:0 | 14.88 | 5.75 | 5.46 | 6.57 | 6.89 | 7.05 | 29.41 |
| 16:1 | 0.20 | 0.30 | 0.30 | 0.28 | 0.30 | 0.27 | 0.34 |
| 18:0 | 12.24 | 7.04 | 7.06 | 11.16 | 11.82 | 13.42 | 3.37 |
| 18:1 | 37.16 | 62.36 | 63.33 | 59.65 | 58.45 | 59.94 | 49.20 |
| 18:2 | 31.38 | 19.24 | 18.97 | 17.62 | 17.66 | 14.22 | 13.87 |
| 18:3 | 2.76 | 1.88 | 2.04 | 1.90 | 1.86 | 2.03 | 1.25 |
| 20:0 | 0.39 | 0.97 | 0.70 | 0.69 | 0.76 | 0.82 | 0.55 |
| 20:1 | 0.23 | 1.28 | 1.22 | 1.15 | 1.14 | 1.14 | 0.77 |
| 20:2 | 0.02 | 0.06 | 0.05 | 0.05 | 0.05 | 0.04 | 0.03 |
| 22:0 | 0.32 | 0.44 | 0.36 | 0.35 | 0.37 | 0.40 | 0.22 |
| 22:1 | 0.04 | 0.17 | 0.05 | 0.05 | 0.13 | 0.09 | 0.18 |
| 24:0 | 0.11 | 0.28 | 0.20 | 0.19 | 0.21 | 0.22 | 0.14 |
| 24:1 | 0.06 | 0.16 | 0.18 | 0.21 | 0.21 | 0.21 | 0.12 |
| Total Trans | 10.5 | 0.7 | 0.7 | 0.6 | 0.7 | 0.7 | 0.5 |
| Total Sats | 28.14 | 14.54 | 13.86 | 19.09 | 20.19 | 22.05 | 34.23 |
| Day 0 | | | | | | | |
| PV | 0.06 | 0.55 | 0.46 | 0.57 | 0.34 | 0.62 | 3.90 |
| Odor | 9 | 9 | 8 | 9 | 9 | 9 | 8 |
| Color, red | 0.5 | 0.6 | 0.7 | 0.7 | 0.7 | 0.7 | 2.0 |
| Color, yellow | 4.0 | 7.0 | 0.0 | 7.0 | 6.0 | 8.0 | 11.0 |
| Flavor | 9 | 8 | 8 | 8 | 9 | 8 | 8/7 |
| FFA, % | 0.04 | 0.03 | 0.03 | 0.03 | 0.03 | 0.03 | 0.04 |
| AOM | 34.47 | 80.26 | 84.67 | 87.41 | 87.46 | 91.34 | 79.59 |
| Day 1 | | | | | | | |
| PV | 0.11 | 0.66 | 0.67 | 0.85 | 0.56 | 0.69 | 3.95 |
| Odor | 8 | 9 | 8/7 | 8 | 8 | 8 | 8/7 |
| Color, red | 0.7 | 1.0 | 0.7 | 0.7 | 0.7 | 1.0 | 2.0 |
| Color, yellow | 4.0 | 7.0 | 6.0 | 8.0 | 7.0 | 8.0 | 13.0 |
| Flavor | 8 | 8 | 8 | 8 | 8 | 8 | 7 |
| Day 3 | | | | | | | |
| PV | 0.27 | 0.81 | 0.79 | 0.99 | 0.71 | 0.90 | 4.35 |
| Odor | 8 | 8/7 | 7 | 8 | 8 | 8 | 7/6 |
| Color, red | 1.0 | 1.1 | 1.1 | 1.1 | 1.0 | 1.2 | 2.5 |
| Color, yellow | 7.0 | 8.0 | 7.0 | 8.0 | 9.0 | 9.0 | 13.0 |
| Flavor | 8 | 7 | 7 | 7/8 | 7/8 | 8/7 | 7/6 |
| Day 6 | | | | | | | |
| PV | 2.35 | 1.40 | 1.11 | 1.21 | 1.16 | 1.21 | 4.60 |
| Odor | 7/8 | 7 | 7/6 | 7 | 7 | 7 | 6 |
| Color, red | 1.2 | 1.3 | 1.3 | 1.3 | 1.3 | 1.3 | 2.0 |
| Color, yellow | 13.0 | 9.0 | 9.0 | 9.0 | 10.0 | 11.0 | 14.0 |
| Flavor | 7/8 | 7 | 7/6 | 7 | 7 | 7 | 7/6 |
| Day 9 | | | | | | | |
| PV | 13.68 | 1.93 | 1.57 | 1.79 | 1.66 | 1.92 | 4.88 |
| Odor | 7/6 | 7/6 | 6 | 7/6 | 7 | 6 | 6/5 |
| Color, red | 1.2 | 1.5 | 1.5 | 1.5 | 1.5 | 1.5 | 2.5 |
| Color, yellow | 14.0 | 10.0 | 10.0 | 10.0 | 11.0 | 12.0 | 15.0 |
| Flavor | 6 | 6 | 6 | 6 | 6 | 6 | 6/5 |
| Day 13 | | | | | | | |
| PV | 25.94 | 2.50 | 2.23 | 2.38 | 2.03 | 2.25 | 5.18 |
| Odor | 6/5 | 5 | 4/3 | 4/3 | 5 | 5 | 5/4 |
| Color, red | 1.2 | 1.5 | 2.0 | 1.5 | 1.5 | 1.6 | 2.5 |
| Color, yellow | 14.0 | 11.0 | 10.0 | 10.0 | 12.0 | 12.0 | 15.0 |
| Flavor | 5 | 5 | 3 | 4/3 | 5 | 5 | 4 |
| Day 15 | | | | | | | |
| PV | 28.92 | 2.85 | 2.44 | 2.61 | 2.39 | 2.56 | 5.51 |
| Odor | 2 | 5/4 | 2 | 2 | 3 | 2 | 3/2 |
| Color, red | 1.5 | 2.0 | 2.0 | 2.0 | 1.5 | 1.7 | 2.5 |
| Color, yellow | 14.0 | 12.0 | 12.0 | 11.0 | 12.0 | 12.0 | 15.0 |
| Flavor | 1 | 4 | 1 | 2 | 2 | 2 | 2 |

*Crisco = partially hydrogenated soybean and cottonseed oils, mono- and di-glycerides.

### Example 2

### Preparation of Shortenings

RBD CV 65® canola oil and deodorized cottonseed stearine were combined in different amounts as indicated below. These blends were votated and then tempered. The results obtained are shown below.

Experiment 1 involved votating 227 kg of a blend of 93% CV 65® and 7% hydrogenated cottonseed; 227 kg of a blend of 95% CV 65® and 5% hydrogenated cottonseed; and 227 kg of a blend of 87.5% CV 65® and 12.5% hydrogenated cottonseed.

Experiment 2 involved votating 1300 kg of a blend of 87.5% CV 65® and 12.5% hydrogenated cottonseed; 650 kg of a blend of 86% CV 65® and 14% hydrogenated cottonseed; and 550 kg of a blend of 93% CV 65® and 7% hydrogenated cottonseed.

Experiment 3 involved votating 935 kg of a blend of 84% CV 65® and 16% hydrogenated cottonseed; and 935 kg of a blend of 95% CV 65® and 5% hydrogenated cottonseed.

The ingredients were combined in stainless steel jacketed tanks. The RBD CV 65® was added first and then the cottonseed stearine. The mixture was then heated to 70±5° C. and maintained at that temperature until all the stearine had dissolved. 150 ppm of an anti-oxidant (TBHQ; Eastman Chemical Co., Kingsport, Tenn.) was added to the blend. The mixture was then cooled to 60±5° C. prior to votation.

The crystallization of blends by heat removal using an externally cooled scraped surface heat exchanger results in the creation of small uniform P crystals in the shortening. The votator was set-up to run on glycol as a cooling medium and the scraped-surface heat exchangers were configured in series so that after the A unit, the partially-chilled blend passed to the C unit. From the C unit, the shortening passed to the agitated B unit or “pin” unit. In Experiment 1, nitrogen was not added during votation. In Experiments 2 and 3, 12-15% nitrogen was added to the discharge side of the votator pump. The shortening then passed through an extrusion valve that was placed after the B unit. The RPM of the A & C units was set at 400 rmp and the B unit was set at 100 RPM for all runs. The glycol temperature was set at −8° C. for all the runs. The operating parameters for all runs are shown below in Table 8.

TABLE 8
Parameters for Making Shortenings

| | Product | | A Unit | C Unit | B Unit | | Extension |
|---|---|---|---|---|---|---|---|
| | RBD CV | Feedrate | Outlet | Outlet | Outlet | N₂ | Pressure |
| Experiment | 65 ®:CSHF | (kg/hr) | (° C.) | (° C.) | (° C.) | (%) | (PSI) |
| 1 | 95:5 | ~100 | 31-32 | 22-23 | 23-24 | 0 | 0 |
| 1 | 93:7 | ~100 | 32-34 | 22-23 | 23-25 | 0 | 0 |
| 1 | 87.5:12.5 | ~100 | 33-34 | 25-26 | 28-29 | 0 | 0 |
| 2 | 93:7 | 100-105 | 26-28 | 22-23 | 23-24 | 12-15 | 50 |
| 2 | 87.5:12.5 | 100-120 | 29-32 | 22-24 | 27-30 | 12-15 | 65 |
| 2 | 86:14 | 120-130 | NA | 22-24 | 30-32 | 12-15 | 65 |
| 3 | 95:5 | 95-100 | 31-33 | 21-22 | 22-23 | 12-15 | 95-110 |
| 3 | 84:16 | 100-110 | 40-44 | 27-30 | 38-40 | 12-15 | 175-190 |

The following was used for votation: Scraped surface A unit with a 2¼″ diameter concentric shaft (3″×12″ Model IC312A, Serial #81175VA; Chemtron Corp., Louisville, Ky.); agitated B unit (4″×17¾″ Model 201848, Serial #B668; Chemtron Corp., Louisville, Ky.); and scraped surface C unit with a 2⅛″ diameter eccentric shaft (3″×12″ Model IE312A, Serial #81175VA; Chemtron Corp., Louisville, Ky.). The votated product was packaged into 4-liter and 20-liter plastic pails.

The shortenings containing 12.5% or 14% cottonseed stearine were tempered for 48 hours at a temperature between 23-26° C. The shortenings containing 5% or 7% cottonseed stearine were tempered for 48 hours at a temperature between 20-22° C. The shortening containing 16% cottonseed stearine was tempered for 48 hours at a temperature between 25-28° C.

The shortening was analyzed using the following methods:

| | |
|---|---|
| Peroxide Value | AOCS Cd 8-53 |
| Free Fatty Acids | AOCS Ca 5a-40 |
| Color | Auto Tintometer Lovibond Colour, PFX 990 |
| Mettler Drop Point | AOCS Cc 18-80 |

There were no anomalies noted in the votation of the different blends.

### Example 3

### Yeast Donuts

To test the efficacy and functionality of the shortenings described in Tables 3, 4, and 5, food products were made using such shortenings and compared to food products made using a commercially available hydrogenated vegetable oil and animal shortening.

An American Institute of Baking (AIB) formula was used to evaluate the shortenings in a yeast-leavened donut. The formulas and processes for screening are described below. The control baking formula included Master Chef® All-Purpose Vegetable Shortening (non-emulsified; Cargill, Minnetonka, Minn.) in the dough and the control donuts were fried in Hi-Melt Donut Frying Shortening (Cargill, Minnetonka, Minn.). Each test shortening, e.g., TE-4-350, TE-3-125, or TE-3-70 was used in a dough and as the respective frying shortening.

| | | |
|---|---|---|
| Yeast Donut Formula | grams | % |

| | | | |
|---|---|---|---|
| Flour (bread) | (Pillsbury ®) | 60 | 40.00 |
| Flour (cake) | (Softasilk ®) | 20 | 13.33 |
| Sugar Retail | (C&H ®) | 5 | 3.33 |
| Shortening | | 9 | 6.00 |
| Non-Fat Dry Milk | (Fischer ® low heat) | 4.6 | 3.07 |
| Salt | (Morton ®) | 1.4 | 0.93 |
| Yeast | (Red Star Cake ®) | 5 | 3.33 |
| Water | | 45 | 30.00 |
| | | 150 | 100.000 |

Each dough was mixed in a 300 g bowl farinograph mixer set to 25° C. until peak development was reached. The dough was dried in the farinograph bowl for 1 minute. The yeast was then dispersed in water. The water/yeast slurry was added to the farinograph bowl and mixed for 2 minutes on speed #2. The shortening was added and each dough was mixed to a peak Brabender Unit (BU; see below) (about 15 to 20 minutes total). Dough temperature was between 80° F. and 85° F. The dough was rested in a mixing bowl covered with Saran Wrap® for about 10 minutes, and sheeted to about 0.5 inches (setting #7). Light dusting flour was used during sheeting. The donuts were cut with a cutter having a 3″ outer cut and a 1″ center cut. The dough was placed on Pamn®-sprayed proofing screens on a small tray, and the trays were placed in the proofer (105° F. dry, 100° F. wet) for 30 minutes. The donuts were placed into frying oil (370° F.) for 40 seconds on one side and 45 seconds on the other side. Donuts were fried in the following order: control 1, TE-3-125, TE-4-350, TE-3-70, and control 2. The donuts were removed from the oil and placed on a rack for cooling. Duplicate control doughs were made to help distinguish potential processing effects from shortening effects.

The donuts were analyzed for volume, height, diameter and color using DIPIX® technology (Table 9). DIPIX® results are reported as an average of 5 donuts with the corresponding standard deviation (SD).

Finished donuts were held at ambient temperature for three to four hours before being served blind to the sensory panel. Sensory results were averaged and the means determined using ANOVA (Stat Soft®). Results from the sensory panel are shown in Table 10.

A single donut from each batch was also placed in the center of a paper towel for 24 hours to determine the amount of oil capable of being wicked from the donut.

Physical Attributes

Mix Time

All doughs required about a 10-minute mix to achieve peak Brabender Unit (BU). Shortening type had no apparent effect on mix time. See Table 11.

Dough Brabender Unit (BU)

All doughs resulted in finished BU's in the range of 690 to 710. Shortening type had no apparent effect on dough BU. See Table 11.

Peak Height

The average height of donuts made using each of the test shortenings were within one standard deviation of the average height of control donuts. Shortening type had no apparent effect on the average height of yeast donuts.

Diameter

The average diameter of donuts made using each of the test shortenings were within one standard deviation of the average diameter of control donuts. Shortening type had no apparent effect on the average diameter of yeast donuts.

Volume

The average volumes of donuts made using each of the test shortenings were within one standard deviation of the average volume of control donuts. Shortening type had no apparent effect on the volume of yeast donuts.

Color

The color scores of donuts made using each of the test shortenings were within one standard deviation of the color scores of control donuts. Shortening type had no apparent effect on yeast donut color.

Oil Absorption

The donuts made using each of the test shortenings wicked more oil onto a paper towel than the amount wicked by control donuts. Donuts made using the TE-3-70 test shortening appeared to wick more oil onto a paper towel than donuts made using the TE-3-125 or TE-4-350 test shortenings.

Sensory Attributes (significance=p<0.05)

Color

There were no significant differences in color between donuts made using each of the test shortenings and the control donuts.

Tenderness

The donuts made using TE-3-125 were significantly less tender than donuts made using the other test shortenings or the control donuts.

Gumminess

There were no significant differences in gumminess between donuts made using each of the test shortenings and the control donuts.

Moistness

There were no significant differences in moistness between donuts made using each of the test shortenings and the control donuts. Donuts made using TE-3-125 were directionally lower in moistness than donuts made using the other test shortenings or the control donuts.

Flavor Quality

There were no significant differences in flavor quality between donuts made using each of the test shortenings and the control donuts. The control donuts appeared to be directionally higher in flavor quality than the donuts made using each of the test shortenings.

Mouth Coating

There were no significant differences in mouth coating between donuts made using each of the test shortenings and the control donuts.

Finger Oiliness

There were no significant differences in finger oiliness between donuts made using each of the test shortenings and the control donuts.

Graininess

There were no significant differences in graininess between donuts made using each of the test shortenings and the control donuts.

TABLE 9
DIPIX ® Results for Yeast Donuts

| | Height (mm) | SD (mm) |
|---|---|---|
| Control 1 | 32.0 | 1.05 |
| Control 2 | 33.1 | 0.85 |
| TE-3-125 | 32.2 | 0.74 |
| TE-3-70 | 32.8 | 0.61 |
| TE-4-350 | 33.5 | 1.42 |

| | Diameter (mm) | SD (mm) |
|---|---|---|
| Control 1 | 93.4 | 1.95 |
| Control 2 | 94.8 | −2.57 |
| TE-3-125 | 93.6 | 1.13 |
| TE-3-70 | 93.7 | 1.73 |
| TE-4-350 | 93.0 | 2.01 |
| | Volume (cm³) | SD (cm³) |
| Control 1 | 171.5 | 9.5 |
| Control 2 | 181.6 | 10.5 |
| TE-3-125 | 175.5 | 6.4 |
| TE-3-70 | 178.3 | 9.2 |
| TE-4-350 | 169.0 | 10.9 |

| | Color | SD |
|---|---|---|
| Control 1 | 32.2 | 1.1 |
| Control 2 | 36.3 | 1.24 |
| TE-3-125 | 35.1 | 3.5 |
| TE-3-70 | 34.0 | 3.1 |
| TE-4-350 | 33.8 | 0.8 |

| | Hole Area | |
|---|---|---|
| | (mm²) | SD (mm²) |
| Control 1 | 93.4 | 1.95 |
| Control 2 | 94.8 | −2.57 |
| TE-3-125 | 93.6 | 1.13 |
| TE-3-70 | 93.7 | 1.73 |
| TE-4-350 | 93.0 | 2.01 |

TABLE 10
Yeast Donut Sensory Panel Results

| | | | | | | Flavor | Mouth | Finger | |
|---|---|---|---|---|---|---|---|---|---|
| Panelist | | Color | Tenderness | Gumminess | Moistness | Quality | Coat | Oil | Graininess |
| 1 | Control 1 | 25 | 35 | 15 | 35 | 50 | 15 | 35 | 20 |
| 2 | Control 1 | 38 | 46 | 12 | 46 | 40 | 29 | 14 | 10 |
| 3 | Control 1 | 25 | 39 | 45 | 45 | 45 | 15 | 12 | 20 |
| 4 | Control 1 | 30 | 45 | 40 | 40 | 40 | 20 | 25 | 25 |
| 5 | Control 1 | 52 | 20 | 13 | 28 | 20 | 35- | 35 | 36 |
| 6 | Control 1 | 15 | 45 | 20 | 45 | 40 | 15 | 10 | 10 |
| Mean | | 30.8 | 38.3 | 24.2 | 39.8 | 39.2 | 21.5 | 21.8 | 20.2 |
| 1 | Control 2 | 25 | 35 | 15 | 35 | 50 | 15 | 25 | 25 |
| 2 | Control 2 | 38 | 46 | 12 | 44 | 35 | 49 | 10 | 20 |
| 3 | Control 2 | 25 | 40 | 45 | 45 | 45 | 15 | 12 | 20 |
| 4 | Control 2 | 30 | 40 | 50 | 40 | 30 | 45 | 50 | 15 |
| 5 | Control 2 | 40 | 30 | 25 | 45 | 25 | 43 | 42 | 15 |
| 6 | Control 2 | 20 | 50 | 10 | 45 | 45 | 10 | 20 | 5 |
| Mean | | 29.7 | 40.2 | 26.2 | 42.3 | 38.3 | 29.5 | 26.5 | 16.7 |
| 1 | TE-4-350 | 30 | 40 | 15 | 35 | 55 | 25 | 35 | 20 |
| 2 | TE-4-350 | 38 | 39 | 15 | 44 | 29 | 30 | 10 | 10 |
| 3 | TE-4-350 | 30 | 35 | 45 | 45 | 45 | 15 | 13 | 20 |
| 4 | TE-4-350 | 30 | 30 | 30 | 30 | 5 | 35 | 20 | 20 |
| 5 | TE-4-350 | 33 | 38 | 20 | 40 | 30 | 31 | 28 | 20 |
| 6 | TE-4-350 | 25 | 45 | 20 | 45 | 35 | 10 | 15 | 15 |
| Mean | | 31.0 | 37.8 | 24.2 | 39.8 | 33.2 | 24.3 | 20.2 | 17.5 |
| 1 | TE-3-70 | 35 | 35 | 15 | 35 | 55 | 15 | 35 | 15 |
| 2 | TE-3-70 | 38 | 39 | 20 | 39 | 21 | 54 | 24 | 20 |
| 3 | TE-3-70 | 25 | 40 | 45 | 45 | 45 | 15 | 12 | 20 |
| 4 | TE-3-70 | 30 | 40 | 50 | 46 | 13 | 20 | 40 | 20 |
| 5 | TE-3-70 | 33 | 25 | 9 | 30 | 20 | 40 | 37 | 27 |
| 6 | TE-3-70 | 20 | 45 | 10 | 45 | 40 | 20 | 15 | 10 |
| Mean | | 30.2 | 37.3 | 24.8 | 40.0 | 32.3 | 27.3 | 27.2 | 18.7 |
| 1 | TE-3-125 | 25 | 30 | 15 | 30 | 50 | 20 | 35 | 20 |
| 2 | TE-3-125 | 38 | 32 | 20 | 30 | 24 | 43 | 5 | 5 |
| 3 | TE-3-125 | 25 | 39 | 45 | 45 | 45 | 15 | 13 | 20 |
| 4 | TE-3-125 | 30 | 30 | 30 | 30 | 20 | 30 | 30 | 20 |
| 5 | TE-3-125 | 52 | 15 | 18 | 39 | 20 | 30 | 31 | 21 |
| 6 | TE-3-125 | 10 | 40 | 15 | 40 | 40 | 20 | 5 | 5 |
| Mean | | 30.0 | 31.0 | 23.8 | 35.7 | 33.2 | 26.3 | 19.8 | 15.2 |

TABLE 11
Brabender Units of Doughs

| | Control 1 | TE-3-125 | TE-4-350 | TE-3-70 | Control 2 |
|---|---|---|---|---|---|
| BU | 690 | 720 | 710 | 690 | 710 |
| Mix time (min) | 10.5 | 10.5 | 10.5 | 10.5 | 10 |

Sensory results were analyzed using Duncan's means testing (Stat Soft®) (Table 12).

TABLE 12
Yeast Donut Sensory

| | Duncan test; Variable Tenderness | | | | | |
|---|---|---|---|---|---|---|
| | Approximate Probabilities for Post Hoc Tests | | | | | |
| | Error: Between MS = 23.003, Degrees of Freedom (df) = 20.000 | | | | | |
| | | (1) | (2) | (3) | (4) | (5) |
| Cell | Sample | 37.333 | 38.333 | 40.167 | 37.833 | 31.000 |
| 1 | TE-3-70 | | 0.737264 | 0.360220 | 0.858648 | 0.033345 |
| 2 | Control 1 | 0.737264 | | 0.515629 | 0.858648 | 0.023145 |
| 3 | Control 2 | 0.360220 | 0.515629 | | 0.435736 | 0.006509 |
| 4 | TE-4-350 | 0.858648 | 0.858648 | 0.435736 | | 0.028821 |
| 5 | TE-3-125 | 0.033345 | 0.023145 | 0.006509 | 0.028821 | |

### Example 4

### Cake Donuts

An AIB formula was used to evaluate the shortenings in a cake donut. The formulas and processes are described below. The control formula included Master Chef® All-Purpose Vegetable Shortening (non-emulsified) in the dough. The control dough was fried in Hi-Melt® Donut Frying Shortening. The indicated test shortenings were used in the donut doughs and as the frying shortening. Duplicate control doughs were made to help separate potential process effects from shortening effects.

| | | AIB Formula | |
|---|---|---|---|
| Cake Donut Formula | | (g) | (%) |
| Cake Flour | (Softasilk ®) | 373.3 | 29.28 |
| Bread Flour | (Pillsbury ®) | 160 | 12.55 |
| Granulated Sucrose | (C&H ®) | 231.3 | 18.14 |
| Dextrose | | 10.7 | 0.84 |
| NFDM | (Fischer ® low heat) | 38.7 | 3.04 |
| Salt | (Morton ®) | 12 | 0.94 |
| Baking Soda | (Arm & Hammer ®) | 8 | 0.63 |
| SAPP 40 | (FMC ®) | 11 | 0.86 |
| Nutmeg | (McCormick ®) | 0.65 | 0.05 |
| Mace | (McCormick ®) | 0.4 | 0.03 |
| Liquid Egg Yolk | | 100 | 7.84 |
| Shortening | | 33.3 | 2.61 |
| Vanilla | (McCormick ®) | 2.7 | 0.21 |
| Water | | 292.7 | 22.96 |
| | | 1274.75 | 100.0 |

The dry ingredients were mixed on low speed in a Kitchenaid® 5 qt mixer. The liquids and shortening were added and mixed for 1 minute on low and 2 minutes on medium. The donut maker was set to setting #3, and the donuts were fried at 370° F. for 45 seconds on the first side and 35 seconds on the second side.

The donuts were analyzed on the DIPIX® machine for volume, height, diameter, and color. DIPIX® results are reported as an average of 9 donuts with the corresponding standard deviation (SD) (Table 13).

Finished donuts were held at ambient temperature for three to four hours before being served blind to the sensory panel. Sensory results were averaged (Table 14) and the means were tested using ANOVA and Duncan's means testing (Stat Soft®).

A single donut from each batch was also placed in the center of a paper towel for 24 hours to determine the amount of oil capable of being wicked from the donut.

Physical Attributes

Height

The average height of donuts made using each of the test shortenings were within one standard deviation of the average height of control donuts. Shortening type had no apparent effect on the average height of cake donuts.

Diameter

The average diameter of donuts made using each of the test shortenings were within one standard deviation of the average diameter of control donuts. Shortening type had no apparent effect on the diameter of cake donuts.

Volume

The average volumes of donuts made using each of the test shortenings were within one standard deviation of the average volume of control donuts. Shortening type had no apparent effect on the volume of cake donuts.

Color

The color scores of donuts made using each of the test shortenings were within one standard deviation of the color score of control donuts. Shortening type had no apparent effect on the color of cake donuts.

Oil Absorption

The donuts made using each of the test shortenings wicked more oil onto a paper towel than the amount wicked by control donuts. Donuts made using the TE-3-70 test shortening appeared to wick more oil onto a paper towel than those made using the TE-3-125 and TE-4-350 test shortenings.

Sensory Attributes (significance=p<0.05)

Color

There were no significant differences in color between donuts made using each of the test shortenings and the control donuts.

Tenderness

There were no significant differences in tenderness between donuts made using each of the test shortenings and the control donuts.

Gumminess

There were no significant differences in gumminess between donuts made using each of the test shortenings and the control donuts.

Moistness

There were no significant differences in moistness between donuts made using each of the test shortenings and the control donuts.

Flavor Quality

The donuts made using the TE-4-350 test shortening had significantly less flavor quality than the donuts made using the other test shortenings or the control donuts.

Mouth Coating

There were no significant differences in mouth coating between donuts made using each of the test shortenings and the control donuts.

Finger Oiliness

Donuts made using the TE-3-70 and the TE-3-125 test shortenings were judged as having significantly higher finger oiliness than the control donuts. Donuts made using the TE-3-70 shortening were judged as having the highest finger oiliness. Donuts made using the TE-4-350 shortening appeared to be directionally higher in finger oiliness compared to control donuts.

Graininess

Donuts made using the TE-3-70 test shortening had significantly finer graininess than the control donuts and donuts made using the TE-4-350 test shortening.

TABLE 13
DIPIX ® Results for Cake Donuts

| | Height (mm) | SD (mm) |
|---|---|---|
| Control 1 | 25.9 | 1.4 |
| Control 2 | 30.3 | 1.6 |
| TE-3-125 | 28.9 | 1.6 |
| TE-3-70 | 28.7 | 1.8 |
| TE-4-350 | 28.2 | 1.3 |

| | Diameter | |
|---|---|---|
| | (mm) | SD (mm) |
| Control 1 | 71.3 | 3.3 |
| Control 2 | 68.6 | 2.6 |
| TE-3-125 | 70.1 | 2.2 |
| TE-3-70 | 69.5 | 3.1 |
| TE-4-350 | 70.9 | 3.2 |

| | Volume (cm³) | SD (cm³) |
|---|---|---|
| Control 1 | 98.1 | 3.9 |
| Control 2 | 110.9 | 3.7 |
| TE-3-125 | 109.1 | 4.7 |
| TE-3-70 | 105.5 | 5.7 |
| TE-4-350 | 107.9 | 4.9 |

| | Color* | SD |
|---|---|---|
| Control 1 | 17.0 | 2.45 |
| Control 2 | 14.4 | 0.98 |
| TE-3-125 | 13.2 | 1.94 |
| TE-3-70 | 13.9 | 1.2 |
| TE-4-350 | 15.1 | 2.1 |

| | Hole area | |
|---|---|---|
| | (mm²) | SD (mm²) |
| Control 1 | 204.9 | 110.2 |
| Control 2 | 37.5 | 36.6 |
| TE-3-125 | 79.7 | 80.1 |
| TE-3-70 | 113.7 | 94.7 |
| TE-4-350 | 113.1 | 100.8 |

*higher number = lighter

TABLE 14
Cake Donut Sensory

| | | | | | | Flavor | Mouth | Finger | |
|---|---|---|---|---|---|---|---|---|---|
| Panelist | | Color | Tenderness | Gumminess | Moistness | Quality | Coat | Oiliness | Graininess |
| 1 | Control 1 | 30 | 40 | 10 | 40 | 50 | 25 | 30 | 35 |
| 2 | Control 1 | 22 | 35 | 10 | 30 | 40 | 12 | 13 | 44 |
| 3 | Control 1 | 25 | 37 | 30 | 30 | 47 | 12 | 15 | 29 |
| 4 | Control 1 | 32 | 20 | 29 | 50 | 30 | 15 | 15 | 42 |
| 5 | Control 1 | 30 | 40 | 40 | 40 | 40 | 10 | 20 | 10 |
| 6 | Control 1 | 35 | 45 | 10 | 35 | 35 | 20 | 5 | 40 |
| Mean | | 29 | 36.2 | 21.5 | 37.5 | 40.3 | 15.7 | 14.7 | 33.3 |
| 1 | TE-3-125 | 30 | 30 | 10 | 40 | 50 | 20 | 25 | 40 |
| 2 | TE-3-125 | 31 | 35 | 13 | 40 | 45 | 13 | 13 | 22 |
| 3 | TE-3-125 | 33 | 32 | 30 | 28 | 42 | 12 | 19 | 29 |
| 4 | TE-3-125 | 33 | 28 | 6 | 46 | 40 | 16 | 20 | 33 |
| 5 | TE-3-125 | 40 | 40 | 50 | 40 | 30 | 30 | 30 | 25 |
| 6 | TE-3-125 | 30 | 50 | 20 | 40 | 35 | 20 | 6 | 16 |
| Mean | | 32.8 | 35.8 | 21.5 | 39.0 | 40.3 | 18.5 | 18.8 | 27.5 |
| 1 | TE-3-70 | 30 | 30 | 10 | 40 | 50 | 15 | 25 | 30 |
| 2 | TE-3-70 | 30 | 40 | 10 | 31 | 44 | 12 | 13 | 28 |
| 3 | TE-3-70 | 31 | 33 | 30 | 28 | 42 | 12 | 23 | 21 |
| 4 | TE-3-70 | 33 | 28 | 6 | 46 | 40 | 10 | 14 | 26 |
| 5 | TE-3-70 | 40 | 40 | 40 | 40 | 24 | 22 | 30 | 10 |
| 6 | TE-3-70 | 30 | 45 | 10 | 34 | 30 | 26 | 15 | 10 |
| Mean | | 32.3 | 36.0 | 17.7 | 36.5 | 38.3 | 16.2 | 20.0 | 20.8 |
| 1 | TE-4-350 | 30 | 30 | 10 | 35 | 45 | 15 | 25 | 40 |
| 2 | TE-4-350 | 22 | 40 | 10 | 30 | 44 | 12 | 13 | 28 |
| 3 | TE-4-350 | 27 | 32 | 30 | 30 | 42 | 12 | 19 | 29 |
| 4 | TE-4-350 | 33 | 38 | 20 | 40 | 10 | 25 | 15 | 42 |
| 5 | TE-4-350 | 40 | 40 | 40 | 40 | 5 | 15 | 30 | 15 |
| 6 | TE-4-350 | 30 | 50 | 10 | 35 | 35 | 25 | 6 | 26 |
| Mean | | 30.3 | 38.3 | 20.0 | 35.0 | 30.2 | 17.3 | 18.0 | 30.0 |
| 1 | Control 2 | 30 | 40 | 10 | 45 | 45 | 20 | 20 | 35 |
| 2 | Control 2 | 31 | 40 | 13 | 40 | 40 | 12 | 13 | 28 |
| 3 | Control 2 | 23 | 39 | 24 | 34 | 46 | 12 | 14 | 38 |
| 4 | Control 2 | 33 | 20 | 20 | 50 | 30 | 15 | 5 | 25 |
| 5 | Control 2 | 30 | 40 | 50 | 50 | 40 | 10 | 30 | 20 |
| 6 | Control 2 | 40 | 50 | 10 | 34 | 40 | 15 | 6 | 40 |
| Mean | | 31.2 | 38.2 | 21.2 | 42.2 | 40.2 | 14.0 | 14.7 | 31.0 |

The volume of donuts from each batch was evaluated using a displacement test. The results for six donuts from each batch were averaged, and indicated that the volume of the donuts made using the test shortenings was similar to the volume of control donuts.

### Example 6

### Biscuits

The biscuit recipe shown below was used to evaluate the effects of the test shortenings in biscuits. The control biscuits included Master Chef® All-Purpose Vegetable Shortening (non-emulsified) in the dough. All biscuit doughs were mixed and kneaded by hand.

| | | |
|---|---|---|
| Biscuit Formula | g | % |

| | | | |
|---|---|---|---|
| Sugar | (C&H ®) | 30 | 2.33 |
| Shortening | | 210 | 16.30 |
| Salt | (Morton ®) | 12 | 0.93 |
| Baking Powder | (Calumet ®) | 36 | 2.80 |
| Whole milk | | 400 | 31.06 |
| Cake flour | (Softasilk ®) | 300 | 23.29 |
| Bread flour | (Pillsbury ®) | 300 | 23.29 |
| | | 1288 | 100.00 |

Biscuits were made as follows. Dry ingredients were sifted into a bowl. Refrigerated shortening was cut into the dry ingredients until the consistency was coarse. The liquids were combined and added to the dry ingredients. The dough was hand mixed until soft, and kneaded lightly 10 to 20 times for about 30 seconds. The dough was rolled between 0.5″ metal rails to achieve a 0.5″-thick sheeted dough. Seven cm diameter biscuits were cut out, placed in ZipLock® freezer bags, and frozen at −110° F. The biscuits were thawed at room temperature for 30 minutes, and baked at 425° F. for 15 to 20 minutes.

The donuts were analyzed on a DIPIX® machine for volume, height, diameter, and color. DIPIX® results are shown below in Table 15 and are reported as an average of 6 biscuits with the corresponding standard deviation (SD).

Finished biscuits were held at ambient temperature for 15 minutes before being served blind to the sensory panel. Sensory results were averaged (Table 16) and means tested using ANOVA and Duncan's means testing (Stat Soft®) (Tables 17 and 18).

Physical Attributes

Average Height

The average height of biscuits made using test shortening TE-3-125 was slightly higher than that of biscuits made using the other test shortenings or of the control biscuits.

Diameter

The average diameters of biscuits made using each of the test shortenings were within one standard deviation of the average diameter of control biscuits. Shortening type had no apparent effect on the average diameter of biscuits.

Volume

The volume of biscuits made using TE-4-350 appeared to be slightly lower than the volume of biscuits made using the other test shortenings or the volume of control biscuits.

Color

The color of biscuits made using TE-3-70 appeared slightly lighter than the color of control biscuits and biscuits made using TE-3-125. The color differences, however, may be due to the location of a biscuit in a bake pan and/or the location of a biscuit in an oven. Biscuits placed on the edge of a pan tended to be darker than those in the center of a pan.

Sensory Attributes (significance=p<0.05)

Color

The color of biscuits made using TE-3-70 appear lighter in color than the color of biscuits made using the other test shortenings or the control biscuits. The color differences, however, may be due to location of a biscuit in a bake pan and/or the location of a biscuit in an oven. Biscuits placed on the edge of a pan tended to be darker than those in the center of a pan.

Tenderness

There were no significant differences in tenderness between biscuits made using each of the test shortenings and the control biscuits.

Gumminess

There were no significant differences in gumminess between biscuits made using each of the test shortenings and the control biscuits.

Moistness

There were no significant differences in moistness between biscuits made using each of the test shortenings and the control biscuits.

Flavor Quality

There were no significant differences in flavor quality between biscuits made using each of the test shortenings and control biscuits.

Mouth Coating

There were no significant differences in mouth coating between biscuits made using each of the test shortenings and control biscuits.

Finger Oiliness

There were no significant differences in finger oiliness between biscuits made using each of the test shortenings and control biscuits.

Graininess

There were no significant differences in graininess between biscuits made using each of the test shortenings and control biscuits.

TABLE 15
DIPIX ® Results for Biscuits

| | Average Height | |
|---|---|---|
| | (mm) | SD (mm) |
| Control 1 | 27.3 | 1.32 |
| TE-3-125 | 29.7 | 0.82 |
| TE-3-70 | 26.4 | 0.53 |
| TE-4-350 | 26.1 | 0.6 |
| | Diameter (mm) | SD (mm) |
| Control 1 | 69.2 | 0.93 |
| TE-3-125 | 68.2 | 0.73 |
| TE-3-70 | 68.9 | 0.94 |
| TE-4-350 | 68.3 | 0.62 |
| | Volume (cm³) | SD (cm³) |
| Control 1 | 103 | 5.5 |
| TE-3-125 | 102.1 | 4.7 |
| TE-3-70 | 98.9 | 3.3 |
| TE-4-350 | 95.8 | 2.1 |

| | Color | SD |
|---|---|---|
| Control 1 | 39.3 | 7.05 |
| TE-3-125 | 36.5 | 1.85 |
| TE-3-70 | 47.3 | 5.06 |
| TE-4-350 | 43.6 | 4.76 |

TABLE 16
Biscuit Sensory

| | | | | | | Flavor | Mouth | Finger | |
|---|---|---|---|---|---|---|---|---|---|
| Panelist | | Color | Tenderness | Gumminess | Moistness | Quality | Coat | Oiliness | Graininess |
| 1 | Control 1 | 27 | 35 | 15 | 30 | 55 | 10 | 20 | 45 |
| 2 | Control 1 | 30 | 38 | 10 | 15 | 35 | 5 | 5 | 38 |
| 3 | Control 1 | 35 | 25 | 20 | 20 | 50 | 10 | 10 | 20 |
| 4 | Control 1 | 28 | 29 | 15 | 26 | 29 | 14 | 7 | 23 |
| 5 | Control 1 | 24 | 40 | 40 | 30 | 30 | 30 | 30 | 30 |
| 6 | Control 1 | 30 | 30 | 15 | 35 | 40 | 25 | 2 | 20 |
| Mean | | 29.0 | 32.8 | 19.2 | 26.0 | 39.8 | 15.7 | 12.3 | 29.3 |
| 1 | TE-3-125 | 35 | 35 | 20 | 30 | 50 | 10 | 15 | 45 |
| 2 | TE-3-125 | 40 | 28 | 5 | 15 | 35 | 8 | 5 | 44 |
| 3 | TE-3-125 | 40 | 20 | 34 | 6 | 50 | 30 | 16 | 26 |
| 4 | TE-3-125 | 35 | 34 | 22 | 17 | 40 | 14 | 7 | 23 |
| 5 | TE-3-125 | 35 | 40 | 40 | 30 | 30 | 30 | 30 | 30 |
| 6 | TE-3-125 | 40 | 50 | 15 | 40 | 40 | 20 | 5 | 15 |
| Mean | | 37.5 | 34.5 | 22.7 | 23.0 | 40.8 | 18.7 | 13.0 | 30.5 |
| 1 | TE-3-70 | 20 | 30 | 25 | 35 | 45 | 10 | 15 | 40 |
| 2 | TE-3-70 | 30 | 19 | 3 | 15 | 35 | 10 | 5 | 30 |
| 3 | TE-3-70 | 10 | 15 | 30 | 10 | 40 | 50 | 30 | 30 |
| 4 | TE-3-70 | 24 | 39 | 12 | 27 | 20 | 30 | 5 | 36 |
| 5 | TE-3-70 | 30 | 40 | 45 | 38 | 30 | 30 | 30 | 35 |
| 6 | TE-3-70 | 20 | 45 | 10 | 35 | 30 | 15 | 5 | 20 |
| Mean | | 22.3 | 31.3 | 20.8 | 26.7 | 33.3 | 24.2 | 15.0 | 31.8 |
| 1 | TE-4-350 | 27 | 30 | 30 | 40 | 40 | 10 | 20 | 40 |
| 2 | TE-4-350 | 30 | 28 | 8 | 15 | 35 | 10 | 5 | 40 |
| 3 | TE-4-350 | 35 | 24 | 34 | 10 | 50 | 35 | 30 | 25 |
| 4 | TE-4-350 | 24 | 48 | 20 | 38 | 30 | 21 | 6 | 19 |
| 5 | TE-4-350 | 25 | 40 | 40 | 30 | 30 | 30 | 30 | 25 |
| 6 | TE-4-350 | 26 | 45 | 20 | 40 | 35 | 15 | 5 | 25 |
| Mean | | 27.8 | 35.8 | 25.3 | 28.8 | 36.7 | 20.2 | 16.0 | 29.0 |
| 1 | Control 2 | 40 | 35 | 15 | 35 | 50 | 10 | 20 | 45 |
| 2 | Control2 | 40 | 23 | 3 | 15 | 35 | 10 | 10 | 30 |
| 3 | Control 2 | 45 | 20 | 22 | 30 | 50 | 20 | 30 | 38 |
| 4 | Control 2 | 30 | 23 | 30 | 20 | 11 | 15 | 9 | 13 |
| 5 | Control 2 | 50 | 40 | 50 | 45 | 30 | 30 | 45 | 35 |
| 6 | Control 2 | 45 | 50 | 10 | 45 | 40 | 20 | 5 | 15 |
| Mean | | 41.7 | 31.8 | 21.7 | 31.7 | 36.0 | 17.5 | 19.8 | 29.3 |

TABLE 17
Biscuit Sensory-Color

| | Duncan test; Variable Color | | | | | |
|---|---|---|---|---|---|---|
| | Approximate Probabilities for Post Hoc Tests | | | | | |
| | Error: Between MS = 29.177, Degrees of Freedom (df) = 20.000 | | | | | |
| | | (1) | (2) | (3) | (4) | (5) |
| Cell | Sample | 22.333 | 29.000 | 41.667 | 27.833 | 37.500 |
| 1 | TE-3-70 | | 0.055288 | 0.000041 | 0.093211 | 0.000215 |
| 2 | Control 1 | 0.055288 | | 0.000902 | 0.712392 | 0.013173 |
| 3 | Control 2 | 0.000041 | 0.000902 | | 0.000489 | 0.196657 |
| 4 | TE-4-350 | 0.093211 | 0.712392 | 0.000489 | | 0.007539 |
| 5 | TE-3-125 | 0.000215 | 0.013173 | 0.196657 | 0.007539 | |

TABLE 18
Biscuit Sensory-Finger Oil

| | Duncan test; Variable Finger Oil | | | | | |
|---|---|---|---|---|---|---|
| | Approximate Probabilities for Post Hoc Tests | | | | | |
| | Error: Between MS = 19.980, Degrees of Freedom (df) = 20.000 | | | | | |
| | | (1) | (2) | (3) | (4) | (5) |
| Cell No. | Sample | 15.000 | 12.333 | 19.833 | 16.000 | 13.000 |
| 1 | TE-3-70 | | 0.340605 | 0.090392 | 0.702616 | 0.447577 |
| 2 | Control 1 | 0.340605 | | 0.015256 | 0.207180 | 0.798908 |
| 3 | Control 2 | 0.090392 | 0.014256 | | 0.153183 | 0.023165 |
| 4 | TE-4-350 | 0.702616 | 0.207180 | 0.153183 | | 0.284807 |
| 5 | TE-3-125 | 0.447577 | 0.798908 | 0.023165 | 0.284807 | |

### Example 7

### Sugar Cookies

The recipe shown below was used to evaluate the test shortenings in sugar cookies. The control formula included Master Chef® All-Purpose Vegetable Shortening (non-emulsified) in the dough.

| Sugar Cookies | | Grams | % |
|---|---|---|---|
| Sugar | (C&H ®) | 374 | 31.17 |
| Shortening | | 226 | 18.83 |
| Salt | (Morton ®) | 7 | 0.58 |
| Sodium Bicarbonate | (Arm & Hammer ®) | 4 | 0.33 |
| Vanilla | (McCormick ®) | 2 | 0.17 |
| Eggs | | 75 | 6.25 |
| Whole milk | | 61 | 5.08 |
| Cake flour | (Softasilk ®) | 225.5 | 18.79 |
| Bread flour | (Pillsbury ®) | 225.5 | 18.79 |
| | | 1200 | 100.00 |

The sugar, shortening, salt, sodium bicarbonate and vanilla were mixed in a KitcheiAid® 5 quart mixer on low speed (1) for 3 min. The eggs were added and mixed on low speed for 3 min. The milk was added and mixed on low speed for 1 min. The flours were sifted and added to the mixture. The mixture was mixed on low speed for 1 min. The cookie dough was deposited on a sheet pan liner using an ice cream scoop. The dough was baked at 400° F. for 12 min, and the cookies were placed on a rack to cool.

The cookies were weighed (Table 19), and analyzed on a DIPIX® machine for volume, height, diameter, and color. DIPIX® results are reported as an average of 9 sugar cookies with the corresponding standard deviation (SD) (Table 20).

Finished cookies were held at ambient temperature for 15 days before being served blind to the sensory panel. Sensory results were averaged (Table 21) and means tested using ANOVA and Duncan's means testing (Stat Soft®) (Table 22).

Physical Attributes

Average Height

The average height of cookies made using each of the test shortenings were within one standard deviation of the average height of control cookies. Shortening type had no apparent effect on the average height of cookies.

Diameter

The diameter of cookies made using TE-3-125 appeared to be slightly larger than the diameter of cookies made using the other test shortenings or the control cookies.

Volume

The volume of cookies made using TE-3-125 appeared to be slightly larger than the volume of cookies made using the other test shortenings or the control cookies.

Color

The color of cookies made using TE-3-125 and TE-3-70 appeared to be slightly darker than cookies made using TE-4-350 or control cookies.

Sensory Attributes (significance=p<0.05)

Color

Cookies made using TE-3-125 and TE-3-70 were significantly darker than cookies made using TE-4-350 or control cookies.

Cracking

There were no significant differences in cracking between cookies made using each of the test shortenings and the control cookies.

Hardness

There were no significant differences in hardness between cookies made using each of the test shortenings and the control cookies.

Chewiness

There were no significant differences in chewiness between cookies made using each of the test shortenings and the control cookies.

Moistness

Cookies made using TE-4-350 were significantly more moist than cookies made using TE-3-70 or TE-3-125, or control cookies.

Flavor Quality

There were no significant differences in flavor between cookies made using each of the test shortenings and control cookies.

Mouth Coating

There were no significant differences in mouth coating between cookies made using each of the test shortenings and control cookies.

TABLE 19
Average Weight of Sugar Cookies

| Shortening | Weight (g) |
|---|---|
| Control | 10.7 |
| TE-3-125 | 11.3 |
| TE-3-70 | 10.4 |
| TE-4-350 | 11.1 |

TABLE 20
DIPIX ® Results for Sugar Cookies

| | Average Height | |
|---|---|---|
| | (mm) | SD (mm) |
| Control 1 | 12.0 | 0.28 |
| TE-3-125 | 11.9 | 0.18 |
| TE-3-70 | 12.4 | 0.51 |
| TE-4-350 | 12.5 | 0.57 |
| | Diameter (mm) | SD (mm) |
| Control 1 | 51.1 | 0.71 |
| TE-3-125 | 53.2 | 0.33 |
| TE-3-70 | 50.0 | 0.64 |
| TE-4-350 | 51.1 | 0.96 |
| | Volume (cm³) | SD (cm³) |
| Control 1 | 24.0 | 0.92 |
| TE-3-125 | 26.5 | 0.18 |
| TE-3-70 | 24.5 | 1.29 |
| TE-4-350 | 25.7 | 1.03 |

| | Color | SD |
|---|---|---|
| Control 1 | 29.5 | 1.70 |
| TE-3-125 | 24.8 | 1.09 |
| TE-3-70 | 23.7 | 1.34 |
| TE-4-350 | 30.4 | 1.77 |

TABLE 21
Sugar Cookie Sensory

| | | | | | | | Flavor | Mouth |
|---|---|---|---|---|---|---|---|---|
| Panelist | | Color | Cracking | Hardness | Chew | Moistness | Quality | Coat |
| 1 | Control | 25 | 35 | 25 | 5 | 10 | 50 | 20 |
| 2 | Control | 30 | 30 | 30 | 0 | 10 | 20 | 10 |
| 3 | Control | 35 | 33 | 42 | 3 | 12 | 40 | 10 |
| 4 | Control | 25 | 42 | 20 | 3 | 33 | 50 | 17 |
| 5 | Control | 28 | 32 | 30 | 20 | 20 | 39 | 11 |
| 6 | Control | 15 | 35 | 20 | 0 | 15 | 40 | 10 |
| Mean | | 26.3 | 34.5 | 27.8 | 5.2 | 16.7 | 39.8 | 13.0 |
| 1 | TE-3-125 | 35 | 30 | 25 | 5 | 10 | 55 | 10 |
| 2 | TE-3-125 | 40 | 20 | 30 | 0 | 10 | 30 | 10 |
| 3 | TE-3-125 | 40 | 40 | 42 | 3 | 10 | 40 | 10 |
| 4 | TE-3-125 | 33 | 42 | 27 | 7 | 33 | 50 | 17 |
| 5 | TE-3-125 | 33 | 29 | 28 | 20 | 17 | 39 | 11 |
| 6 | TE-3-125 | 25 | 40 | 30 | 0 | 10 | 40 | 10 |
| Mean | | 34.3 | 33.5 | 30.3 | 5.8 | 15.0 | 42.3 | 11.3 |
| 1 | TE-4-350 | 25 | 40 | 30 | 5 | 10 | 45 | 20 |
| 2 | TE-4-350 | 30 | 30 | 30 | 0 | 10 | 40 | 10 |
| 3 | TE-4-350 | 25 | 28 | 49 | 3 | 12 | 40 | 12 |
| 4 | TE-4-350 | 24 | 42 | 20 | 7 | 40 | 50 | 5 |
| 5 | TE-4-350 | 30 | 35 | 33 | 19 | 22 | 39 | 11 |
| 6 | TE-4-350 | 15 | 30 | 25 | 0 | 15 | 45 | 10 |
| Mean | | 24.8 | 34.2 | 31.2 | 5.7 | 18.2 | 43.2 | 11.3 |
| 1 | TE-3-70 | 25 | 35 | 20 | 5 | 10 | 45 | 15 |
| 2 | TE-3-70 | 50 | 40 | 30 | 0 | 10 | 35 | 10 |
| 3 | TE-3-70 | 40 | 33 | 42 | 3 | 10 | 40 | 12 |
| 4 | TE-3-70 | 40 | 42 | 27 | 3 | 33 | 50 | 17 |
| 5 | TE-3-70 | 33 | 32 | 22 | 15 | 19 | 39 | 18 |
| 6 | TE-3-70 | 30 | 20 | 15 | 0 | 10 | 40 | 10 |
| Mean | | 36.3 | 33.7 | 26.0 | 4.3 | 15.3 | 41.5 | 13.7 |
| 1 | Control 2 | 30 | 35 | 25 | 5 | 10 | 45 | 20 |
| 2 | Control 2 | 35 | 10 | 30 | 0 | 10 | 45 | 10 |
| 3 | Control 2 | 35 | 24 | 49 | 3 | 12 | 40 | 15 |
| 4 | Control 2 | 24 | 35 | 20 | 7 | 40 | 50 | 5 |
| 5 | Control 2 | 28 | 27 | 37 | 19 | 17 | 39 | 18 |
| 6 | Control 2 | 25 | 35 | 20 | 0 | 15 | 45 | 10 |
| Mean | | 29.5 | 27.7 | 30.2 | 5.7 | 17.3 | 44.0 | 13.0 |

TABLE 22
Sugar Cookie Sensory-Color

| | Duncan test; Variable Color | | | | | |
|---|---|---|---|---|---|---|
| | Approximate Probabilities for Post Hoc Tests | | | | | |
| | Error: Between MS = 16.223, Degrees of Freedom (df) = 20.00 | | | | | |
| | | (1) | (2) | (3) | (4) | (5) |
| Cell No. | Sample | 36.33 | 29.500 | 24.833 | 26.333 | 34.333 |
| 1 | TE-3-70 | | 0.010704 | 0.000194 | 0.000650 | 0.400138 |
| 2 | Control 2 | 0.010704 | | 0.070765 | 0.188556 | 0.050881 |
| 3 | TE-4-350 | 0.000194 | 0.070765 | | 0.526381 | 0.001032 |
| 4 | Control 1 | 0.000650 | 0.188556 | 0.526381 | | 0.003550 |
| 5 | TE-3-125 | 0.400138 | 0.050881 | 0.001032 | 0.003550 | |

### Example 8

### French Fries

Soybean oil that had been hydrogenated to an IV of about 10 was heated to about 140° F. CV 65″ RBD canola oil was heated to about 120° F. and added to the melted hydrogenated soy oil at a proportion of 10% hydrogenated soy to 90% canola oil. The mixture was blended at low speed for about an hour at 120° F. A sample of the mixture was analyzed and the results are shown in Table 23.

TABLE 23
Analysis of Frying Shortening

| | FS-90 |
|---|---|
| CV 65 ® RBD, % | 90 |
| Soybean Oil, % | 10 |
| (partially hydrogenated) | |
| Mettler Drop Point, ° F. | 125 |
| Fatty Acid Profile, % | |
| C16:0 | 5.4 |
| C18:0 | 9.2 |
| C18:1 (trans) | 1.4 |
| C18:1 (cis) | 56.3 |
| C18:2 (trans) | 0.6 |
| C18:2 (cis) | 21.3 |
| C18:3 (trans) | 0.6 |
| C18:3 (cis) | 2.4 |
| Free Fatty Acids, % | 0.04 |
| Total Saturated FA, % | 15.7 |
| Total trans FA, % | 2.6 |
| Iodine Value | 97.3 |
| Peroxide Value, meq/kg | 0 |
| Solid Fat Content, % | |
| 50° F. | 10.1 |
| 70° F. | 8.0 |
| 92° F. | 5.8 |
| 104° F. | 4.5 |

The frying shortening was used to par-fry french fry cut potatoes at a ratio of about 1 pound of frying shortening to about 16 pounds of pared, sliced raw potatoes. The par-fried potatoes were then flash-frozen. Aliquots of the frozen par-fried potatoes were then finish fried in a restaurant model fryer, typically at 340° F. to 360° F. for about 2 to 5 minutes.

### Example 9

### A Sunflower-Palm Shortening Having Little or No Trans-Fatty Acids

A shortening was made as described in Example 1 using high oleic sunflower liquid oil and a palm oil stearine hard fat. A sample of the shortening was analyzed and the results are shown in Table 24.

TABLE 24
Analysis of Shortening

| | TE-3-125SP |
|---|---|
| High Oleic Sunflower RBWD, % | 87.5 |
| Palm Oil Hard Fat (POHF), % | 12.5 |
| Free Fatty Acids, % | 0.04 |
| Peroxide Value, meq/kg | 0.37 |
| Mettler Drop Point, ° F. | 117.0 |
| AOM, hours | 51.5 |
| Fatty Acid Profile, % | |
| C16:0 | 8.3 |
| C16:1 | 0.1 |
| C18:0 | 9.8 |
| C18:1 | 73.0 |
| C18:2 | 6.9 |
| C18:3 | 0.2 |
| C20:0 | 0.3 |
| C20:1 | 0.2 |
| C22:0 | 0.8 |
| C22:1 | 0.1 |
| C24:0 | 0.3 |
| C24:1 | 0.0 |
| Total Saturated FA, % | 19.4 |
| Total trans FA, % | 0.2 |
| Iodine Value | 75.4 |
| Solid Fat Content, % | |
| 50° F. | 13.5 |
| 70° F. | 12.2 |
| 80° F. | 11.3 |
| 92° F. | 9.4 |
| 100° F. | 8.0 |
| 104° F. | 7.2 |
| Additives | none |
| Nitrogen at Votation | yes |

TE-3-125SP is used in the preparation of yeast donuts, cake donuts, biscuits, and sugar cookies. TE-3-125SP is used to fry yeast donuts and to par-fry French fries. TE-3-125SP does not impart any negative flavors or characteristics to the food product.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A shortening comprising about 11% to about 18% by weight hard fat and about 82% to about 89% by weight liquid oil, said liquid oil having from about 0.1% to about 7% α-linolenic acid based on total fatty acid content.

2. The shortening of claim 1, said liquid oil having from about 1.4% to about 4.0% α-linolenic acid.

3. The shortening of claim 1, said liquid oil having from about 7% to about 56% polyunsaturated fatty acids.

4. The shortening of claim 1, said liquid oil having less than about 15% saturated fatty acids.

5. The shortening of claim 1, wherein said liquid oil is selected from the group consisting of canola oil, sunflower oil, safflower oil, and soybean oil.

6. The shortening of claim 1, wherein the hard fat is hydrogenated to an IV of less than 5 meq.

7. The shortening of claim 1, wherein the hard fat is a stearine fraction.

8. The shortening of claim 1, wherein said hard fat is selected from the group consisting of hydrogenated cottonseed oil, cottonseed oil stearine, hydrogenated soybean oil, soybean oil stearine, hydrogenated palm oil, palm oil stearine, hydrogenated canola oil, and canola oil stearine.

9. The shortening of claim 1, further comprising an antioxidant.

10. The shortening of claim 1, said shortening comprising about 12.5% by weight hard fat and about 87.5% by weight liquid oil.

11. The shortening of claim 1, said shortening comprising about 14% by weight hard fat and about 86% by weight liquid oil.

12. The shortening of claim 1, said shortening comprising about 16% by weight hard fat and about 84% by weight liquid oil.

13. The shortening of claim 1, said shortening comprising about 18% by weight hard fat and about 82% by weight liquid oil.

14. The shortening of claim 1, said shortening exhibiting a solid fat content at 92° F. of about 4% to about 16%.

15. The shortening of claim 1, said shortening exhibiting a solid fat content at 104° F. of about 3% to about 13%.

16. The shortening of claim 1, said shortening having about 11% to about 25% by weight saturated fatty acids.

17. The shortening of claim 16, said shortening having about 50% to about 70% by weight monounsaturated fatty acids.

18. The shortening of claim 17, said shortening having about 14% to about 23% by weight polyunsaturated fatty acids.

19. The shortening of claim 18, wherein said shortening has less than about 5% trans-fatty acids.

20. The shortening of claim 1, said shortening having less than about 1.5% by weight trans-fatty acids.

21. The shortening of claim 20, said shortening having about 0.5% to about 1.3% by weight trans-fatty acid isomers.

22. A shortening having a solid fat content at 100° F. of about 2.5% to about 13% and a trans-fatty acid content of about 0.5% to about 1.4%.

23. A food product comprising the shortening of claim 1.

24. The food product of claim 19, wherein said product is selected from the group consisting of cake doughnut mix, raised yeast doughnut mix, sugar cookie mix, frozen biscuit mix, fresh biscuit mix, and machined pastry dough.

25. An edible composition comprising the shortening of claim 1.

26. The edible composition of claim 25, wherein said edible composition is a toaster pastry.

27. A semi-solid fat product having an 18:1 content from about 40% to about 65%, an 18:2 content of about 7% to about 23%, an 18:3 content of about 0% to about 3.0%, and less than about 1.5% by weight trans-fatty acids, based upon total fatty acid content.

28. The fat product of claim 27, said fat product having about 0.5% to about 1.3% by weight trans-fatty acid isomers.

29. The fat product of claim 27, said fat product exhibiting a solid fat content at 92° F. of about 4.0 to about 13.0.

30. The fat product of claim 27, said fat product exhibiting a solid fat content at 100° F. of about 3.0 to about 12.0.

31. The fat product of claim 27, said fat product having an 18:0 content of about 5.0% to about 15.0% based on total fatty acid content.

32. A fat product having a change in peroxide value (PV) of less than 5 meq/kg after 15 days of accelerated aging.

33. A food product comprising the fat product of claim 27.

34. The food product of claim 33, wherein said product is selected from the group consisting of cake doughnut mix, raised yeast doughnut mix, sugar cookie mix, frozen biscuit mix, fresh biscuit mix, and machined pastry dough.

35. An edible composition, comprising a food fried in the fat product of claim 27.

36. A method of making a shortening comprising the steps of:
a) providing a blend comprising about 11% to about 18% by weight hard fat and about 82% to about 89% by weight liquid oil, said liquid oil having from about 0.1% to about 7% α-linolenic acid based on total fatty acid content;
b) cooling said blend; and
c) tempering said blend to make said shortening.

37. The method of claim 36, wherein said cooling step comprises cooling said blend to between about 65° F. to about 82° F. in a scraped surface heat exchanger for about 1.0 to about 1.8 minutes.

38. The method of claim 36, wherein said tempering step comprises tempering at a temperature of about 60° F. to about 90° F.

39. The method of claim 38, wherein said tempering is for about 24 hours to about 72 hours.

40. The method of claim 36, wherein nitrogen is introduced into said blend during said cooling step.

41. A method of making a baked edible composition, comprising the steps of:
a) providing a food product comprising the shortening of claim 1; and
b) baking said food product.

42. A method of making a fried edible composition, comprising the steps of:
a) providing a food product comprising the shortening of claim 1; and
b) frying said food product.

43. The method of claim 42, wherein said food product is fried in the shortening of claim 1.

44. A shortening comprising about 5% by weight hard fat and about 95% by weight liquid oil.

45. A shortening comprising about 7% by weight hard fat and about 93% by weight liquid oil.

46. A semi-solid fat product having an 18:1 content from about 45% to about 75%, an 18:2 content of about 3% to about 10%, an 18:3 content of about 0% to about 3.0%, and less than about 1.5% by weight trans-fatty acids, based upon total fatty acid content.

47. A semi-solid fat product having an 18:1 content from about 50% to about 80%, an 18:2 content of about 0% to about 5%, an 18:3 content of about 0% to about 2.5%, and less than about 1.5% by weight trans-fatty acids, based upon total fatty acid content.

48. A frying shortening comprising about 5% to about 18% by weight hard fat and about 82% to about 95% by weight liquid oil, said liquid oil having from about 0.1% to about 7% α-linolenic acid based on total fatty acid content.

49. The frying shortening of claim 48, wherein said liquid oil is selected from the group consisting of canola oil, sunflower oil, safflower oil, and soybean oil.

50. The frying shortening of claim 48, wherein said hard fat is selected from the group consisting of hydrogenated cottonseed oil, cottonseed oil stearine, hydrogenated soybean oil, soybean oil stearine, hydrogenated palm oil, palm oil stearine, hydrogenated canola oil, and canola oil stearine.

51. The frying shortening of claim 48, said liquid oil having from about 1.4% to about 4.0% α-linolenic acid.

52. The frying shortening of claim 48, further comprising an antioxidant.

53. The frying shortening of claim 48, said shortening comprising about 5% by weight hard fat and about 87.5% by weight liquid oil.

54. The frying shortening of claim 48, said shortening comprising about 7% by weight hard fat and about 86% by weight liquid oil.

55. The frying shortening of claim 48, said shortening comprising about 10% by weight hard fat and about 84% by weight liquid oil.

56. The frying shortening of claim 48, said shortening comprising about 15% by weight hard fat and about 82% by weight liquid oil.

57. The frying shortening of claim 48, said frying shortening exhibiting a solid fat content at 50° F. of about 10%.

58. The frying shortening of claim 48, said frying shortening exhibiting a solid fat content at 70° F. of about 8%.

59. The frying shortening of claim 48, said frying shortening exhibiting a solid fat content at 92° F. of about 6%.

60. The frying shortening of claim 48, said frying shortening exhibiting a solid fat content at 104° F. of about 4.5%.

61. A food product comprising the frying shortening of claim 48.

62. The food product of claim 61, wherein said food product is selected from the group consisting of frozen par-fried potatoes, finish-fried potatoes, frozen onion rings, tortilla chips, corn chips, extruded fried corn coletts, donut mix, sugar cookie mix, frozen biscuit mix, fresh biscuit mix, and machined pastry dough.
